(19) United States
(12) Patent Application Publication
(10) Pub. No.: US 2014/0004492 A1
(43) Pub. Date: Jan. 2, 2014

(54) System, Method, and Article to Prompt Behavior Change

(71) Applicants: David J. O'Reilly, Palo Alto, CA (US); Arna Diana Ionescu, San Francisco, CA (US); Sean Patrick Duffy, San Francisco, CA (US); Jesse Amos Silver, San Francisco, CA (US); David Rae Fetherstonhaugh, Danville, CA (US); Schirin Lucie Rithcer, Palo Alto, CA (US)

(72) Inventors: David J. O'Reilly, Palo Alto, CA (US); Arna Diana Ionescu, San Francisco, CA (US); Sean Patrick Duffy, San Francisco, CA (US); Jesse Amos Silver, San Francisco, CA (US); David Rae Fetherstonhaugh, Danville, CA (US); Schirin Lucie Rithcer, Palo Alto, CA (US)

(73) Assignee: PROTEUS DIGITAL HEALTH, INC., Redwood City, CA (US)

(21) Appl. No.: 13/978,867

(22) PCT Filed: Jan. 6, 2012
(86) PCT No.: PCT/US2012/020542

§ 371 Date: Sep. 20, 2013

Related U.S. Application Data
(60) Provisional application No. 61/431,416, filed on Jan. 10, 2011.

(51) Int. Cl. G09B 19/00

(52) U.S. Cl. CPC G09B 19/00
USPC 434/236

(57) ABSTRACT

System, method, and article to prompt behavior change are provided. Various aspects of the system include health promotion data generated and/or communicated from/to a device; a methodology module associated with software/processor to identify at least one behavior change methodology associated with the health promotion data; and an instruction module associated with a software/processor to initiate the identified at least one behavior change methodology.

### CROSS REFERENCE TO RELATED APPLICATIONS

This application is a 371 National Phase of PCT/US2012/020542, filed Jan. 6, 2012, published as WO 2012/096852, which claims the priority benefit of U.S. Provisional Patent Application No. 61/431,416 entitled “System, Method and Article to Prompt Behavior Change”, filed on Jan. 10, 2011, all of which are incorporated by reference herein in their entirety.

### FIELD OF THE DISCLOSURE

The present disclosure relates generally to the technical fields of health-related devices and communications. More specifically, and in various illustrative embodiments, the present disclosure relates to a system, method, and apparatus of promoting behavior change based on underlying health data.

### INTRODUCTION

Lack of adherence to medication and other health regimens may be a significant issue. Many individuals may fail to engage in behaviors necessary to sustain adherence to therapies. Traditional mental models such as physician instruction, long-term health rewards, and management of disease conditions simply fail to support sustained adherence to the therapies. Such mental models may be quite abstract and difficult to conceive. Patients may not identify with abstractions such as, “If I take this pill every day for the next ten years, I may live longer.” Failure to adhere to therapies may result in unnecessary disease progression, wasted medical resources, and other untoward outcomes.

What is needed, then, is a set of motivators capable of prompting sustained behavior change, etc. that may be associated with various improved outcomes.

### SUMMARY

The present disclosure seeks to address at least some of these problems with a system, method, and article to prompt behavior change. Various aspects include mechanisms for sustaining behavior change in consumers. Such behavior changes may have many and varied positive results, e.g., improved treatment outcomes, broad social usage, charitable benefits to others, etc. The system and method have broad applicability across consumer populations, disease states, geographical territories, and interested stakeholders.

### BRIEF DESCRIPTION OF THE FIGURES

FIG. 1 shows a schematic of a system to prompt behavior change, according to one aspect of the present disclosure.

FIG. 2 shows an operation of the system to prompt a behavior change in FIG. 1, according to one aspect of the present disclosure.

FIG. 2a illustrates one conceptualization of a medmatch methodology, according to one aspect of the present disclosure.

FIG. 3 illustrates one conceptualization of races within a reach methodology, according to one aspect of the present disclosure.

FIG. 4 illustrates one conceptualization of a pick a desktop widget/avatar methodology, according to one aspect of the present disclosure.

FIG. 5 illustrates one conceptualization of a family responsibility methodology, according to one aspect of the present disclosure.

FIG. 6 illustrates one conceptualization of a virtual mansion methodology, according to one aspect of the present disclosure.

FIG. 7 illustrates one conceptualization of a daily hatch methodology, according to one aspect of the present disclosure.

FIG. 8 illustrates one conceptualization of a fitimals methodology, according to one aspect of the present disclosure.

FIG. 9 illustrates one conceptualization of a delightful comparators methodology, according to one aspect of the present disclosure.

FIG. 10 illustrates one conceptualization of an adhere to win methodology, according to one aspect of the present disclosure.

FIG. 11 illustrates one conceptualization of a shame game methodology, according to one aspect of the present disclosure.

FIG. 12 illustrates one conceptualization of a pledge matching methodology, according to one aspect of the present disclosure.

FIG. 13 illustrates one conceptualization of a help from my friends methodology, according to one aspect of the present disclosure.

FIG. 14 illustrates one conceptualization of a love buzz methodology, according to one aspect of the present disclosure.

FIG. 15 illustrates one conceptualization of a patch alerts methodology, according to one aspect of the present disclosure.

FIG. 16 illustrates one conceptualization of a done! buzz methodology, according to one aspect of the present disclosure.

FIG. 17 illustrates one conceptualization of a plug methodology, according to one aspect of the present disclosure.

FIG. 18 illustrates one conceptualization of a real patient profiles methodology, according to one aspect of the present disclosure.

FIG. 19 illustrates one conceptualization of a mood miner methodology, according to one aspect of the present disclosure.

FIG. 20 illustrates one conceptualization of a heart fit methodology, according to one aspect of the present disclosure.

FIG. 21 illustrates one conceptualization of a swimmer patch methodology, according to one aspect of the present disclosure.

FIG. 22 illustrates one conceptualization of a small steps to big results methodology, according to one aspect of the present disclosure.

FIG. 23 illustrates one conceptualization of a commit to healthy eating methodology, according to one aspect of the present disclosure.

FIG. 24 illustrates one conceptualization of a matched methodology, according to one aspect of the present disclosure.

FIG. 25 illustrates a method of prompting behavior change, according to one aspect of the present disclosure.

FIG. 26 is a block diagram representation of an event indicator system with dissimilar metals positioned on opposite ends, according to one aspect of the present disclosure.

FIG. 27 is a block diagram representation of the event indicator system with dissimilar metals positioned on the same end and separated by a non-conducting material, according to one aspect of the present disclosure.

FIG. 28 shows ionic transfer or the current path through a conducting fluid when the event indicator system of FIG. 26 is in contact with conducting liquid and in an active state;

FIG. 28A shows an exploded view of the surface of dissimilar materials of FIG. 28, according to one aspect of the present disclosure.

FIG. 28B shows the event indicator system of FIG. 28 with a pH sensor unit, according to one aspect of the present disclosure.

FIG. 29 is a block diagram illustration of the control device used in the system of FIGS. 26 and 27, according to one aspect of the present disclosure.

FIG. 30 is a functional block diagram of a demodulation circuit that performs coherent demodulation that may be present in a receiver, according to one aspect of the present disclosure.

FIG. 31 illustrates a functional block diagram for a beacon module within a receiver, according to one aspect of the present disclosure.

FIG. 32 is a block diagram of the different functional modules that may be present in a receiver, according to one aspect of the present disclosure.

FIG. 33 is a block diagram of a receiver, according to one aspect of the present disclosure.

FIG. 34 provides a block diagram of a high frequency signal chain in a receiver, according to one aspect of the present disclosure.

FIG. 35 provides a diagram of how a system that includes a signal receiver and an ingestible event marker may be employed, according to one aspect of the present disclosure.

### DETAILED DESCRIPTION

The present disclosure includes multiple embodiments of a system, method, and article to prompt behavior changes. As described hereafter in more details, a system and method of the present disclosure may be used to prompt sustainable behavior changes with various beneficial results. The results, for example, may include improved treatment outcomes, broad social usage, beneficial donations to various recipients, prudent use of medical resources, etc.

Broadly, aspects include various methodologies coupled with devices, e.g., ingestible devices, processor(s), mobile phones, computers, intelligent scales, etc., to promote behavior changes.

Methodologies include, for example, schemas related to matching donations, competitive pursuits, avatar-based approaches, family-centric games, etc.

Versatile aspects provide for linkage of and/or utilization of existing automated systems with the present disclosure. Existing systems may include, for example, computerized matching donation systems, social networks and media, health management networks, etc.

Generally, a patient journey may follow three primary stages of (1) getting started with a therapy regimen for treatment of chronic disease(s); (2) getting into a routine to establish good habits and choices to follow and adhere to the therapy regimen and other positive lifestyle choices, e.g., diet, sleep, exercise, etc.; and (3) getting through rough spots and difficult periods in therapy and disease progression or difficulties to continue to make progress in chronic disease management and continued wellbeing. Aspects of the present disclosure may create product mechanisms for sustained behavior change and continuous reinforcement in each of these stages of the patient journey through the novel use of creative, automated methodologies.

One such methodology facilitates matching donations (sometimes referred to herein as “medmatch”). Under this methodology, personal act(s) of health promotion, e.g., an act of ingestion of a product such as medication or a placebo, are linked to matching altruistic goal(s). The actual confirmation of the personal act, e.g., ingestion event, is a precursor to making such a system work, as opposed to using a surrogate of the act, such as patient memory, patient reporting, smart packaging or bottles, etc.

Using this methodology, aspects of the present disclosure may create product mechanisms for sustained behavior change and continuous reinforcement in the following manner:
1. Get Me Started: medmatch activates a patient's desire to do good by giving back simply by taking the pill(s) already prescribed by their physician.
2. Get Me Into a Routine: medmatch gives a patient short-term reinforcement, connecting the daily and sometimes mundane task of taking a pill to a more inspirational motivation of helping another human being. Medmatch can also connect a patient with others like them, showing how the collective pill ingestions of other patients in the medmatch program are supporting a cause such as ending tuberculosis in India or providing medications to underprivileged children in a neighboring city.
3. Get Me Through the Rough Spots: When a patient has had setbacks in their treatment, side effects from medications, or is feeling down and frustrated about their condition, medmatch provides a higher purpose and motivation to keep going and get back on track, and to not break from the positive routine.

In the medmatch methodology, an important social effect (support for an individual or cause in need) and economic consequence (another product of real financial value being donated) is created by a personal consumer decision, and therefore the “donation transaction” must be verified and quantifiable. Direct measurement of the actual act, e.g., actual ingestion, is part of the product concept. Direct measurement may be accomplished via a variety of devices, as hereinafter discussed.

To illustrate, any individual or group ingests a medication having an integrated, ingestible device that marks an ingestion event. (Examples of such devices are described, for example, in U.S. patent application Ser. No. 12/564,017 filed Sep. 21, 2009 entitled “COMMUNICATION SYSTEM WITH PARTIAL POWER SOURCE,” infra, which was granted as U.S. Pat. No. 7,978,064 on Jul. 12, 2011.) The integrated device communicates relevant data, e.g., health promotion data, identification of an individual, type of medication, time of ingestion, and dosage information, to a computer or mobile device having a processor and specific software. The software/processor process the health promotion data and, upon identification of a predetermined behavior change methodology, the software/processor generate a corresponding instruction to initiate software associated with the identified behavior change methodology.

In one example, the health promotion data identify the individual who has ingested the medication. The software/processor checks a database or other storage media to determine if the identified individual has a corresponding behavior change methodology program in place. Upon determining that such a program is in place, e.g., the individual has selected “medmatch,” the software/processor generates an instruction, e.g., initiates a software program, which facilitates donation of a predetermined nature to particular cause(s).

One such donation, for example, may be provision of a “matching” dose of medication to an individual in need. Thus, upon ingestion of a product by an individual, a “one for one” or “one for many” donation of a second designated product (or multiple products) to another individual, group or cause occurs.

For example, an HIV+ patient living in Boston, Mass., USA may set up medmatch to donate HIV medication to another HIV+ patient living in Nairobi, Kenya every time the Boston patient took his own medication as prescribed. Rather than taking the medication because they are “told to” by their physician or because of a personal sense of longer-term health reward or disease progression fear (mental models which the scientific literature on adherence confirms have failed to support sustained adherence and persistence to drug therapy in the majority of patients living with chronic disease), the medmatch methodology supports and reinforces the act of the Boston patient taking a daily pill by creating a short-term, inspirational goal of helping another individual in need.

The methodology replaces a difficult to conceive abstraction (if I take this pill every day for the next 10 years I will live longer) with a certainty (if I take this pill today I will help someone else today). Over time, this positive daily reinforcement may be complemented by a negative reinforcement as well, in that any personal failure to take the medication as prescribed will result in the removal of the support the Boston patient has been giving to the Nairobi patient.

This negative reinforcement further reinforces and sustains the Boston patient's product usage and adherence.

Medmatch may further allow product manufacturers to associate the persistent and increased usage of their products by consumers with positive social causes that the manufacturers already pursue as part of corporate responsibility, charitable giving, and global health programs. For example, the pharmaceutical company that manufactures the HIV medication for the Boston patient may link medmatch to its global AIDS program and its work with the Gates Foundation, Clinton Global Initiative, WHO and other government-sponsored program to make its expensive HIV medications available to patients in underserved places, and link the medication supplies it already commits for such programs to the ingestion events of individuals like its Boston consumer. This creates a reinforcing, virtuous circle, where the Boston consumer increases and sustains her adherence to the pharmaceutical company's HIV medication, the pharmaceutical company attains further recognition for its global HIV medication access program and credit for it in its primary markets, and the consumer and pharmaceutical company create a new, positive relationship with each other based on the new HIV pill/medmatch brand, a relationship that may be durable beyond such things as the expiration of a patent on the HIV pill itself.

Further, the nature of the consumer/pharmaceutical company relationship based on the medmatch methodology is unique and valuable—the consumer may now perceive herself to be directing and controlling the pharmaceutical company, versus a current perception born of direct-to-consumer (DTC) advertising where the consumer may feel manipulated, overcharged, and controlled by the pharmaceutical company.

Additionally, medmatch may allow companies to have a global health strategy far in advance of when they are capable of having a truly global health infrastructure to support this strategy. Small companies such as assignee Proteus Biomedical, Inc., Redwood City, Calif., USA, may have a viable presence and contribution to global health needs in countries like Kenya, China and India even before such companies are able to have commercial operations in those locations.

Still further, medmatch may facilitate feeding donations back into the donor's own community, such as church groups or professional organizations, e.g., truck drivers helping each other.

Medmatch may further allow consumers and product manufacturers to create online social communities based on the linkage between personal ingestion decisions and medication donations and social causes. Organizing individual participants and recipients into groups may boost motivation because organization increases the perceived impact of an individual's actions. For example, a website may show both the Boston patient's personal impact and the cumulative good a community of other HIV+ patients in the medmatch program has done. Such a social community may have a further reinforcing effect on the individuals like the Boston patient. Through this group dynamic, support and performance becomes another driver for behavior change to adherence, and the cumulative effect that a large community can have on a cause becomes inspirational over and above what any individual can do themselves.

Medmatch need not associate an individual with a single cause related to their own medical condition, or even with health-related causes at all: product manufactures or consumers themselves may create multiple causes and social issues that an individual can select to match to their personal ingestions. An individual, for example, may decide to allocate a portion of their donations to one cause (e.g., HIV in Kenya, where each ingestion, for example, donates one pill) and a portion to another cause (e.g., childhood literacy in San Francisco, for example, where every 100 ingestions by the online cause community to donate a book). A skilled artisan may note that the number of causes and the uses of medmatch to enable those causes may be many and varied to create meaning and motivation for the individuals and their online social groups, such as (a) if the patient meets his or her step-counting goals a pair of shoes is donated to someone in need or a donation is made toward helping those who lost limbs due to landmines; (b) if a patient meets the patient's sleep duration goals a donation is made to a housing project that will provide allow someone in need a safe place to sleep; (c) if a diabetic patient meets their nutritional or weight loss goals food may be donated to people in need (“every pound lost is a pound of food donated”); and (d) other such linkages.

Medmatch may further extend the online social community to link the donating individual or group to the individuals or groups receiving the donations. In this aspect, motivation for the patient is created by the ability of the patient and the donation recipient to share stories and observations about their respective diseases, situations and lives. This social connection may be static, e.g., the Boston patient is able to read a biography and life story about the Nairobi patient, as well dynamic and interactive, e.g., the Boston and Nairobi patients have an ongoing dialogue with updates via various social media and networks such as Twitter™, Facebook™, etc.

Medmatch may further allow consumers who are patients but are not on a device-enabled medication, or are not even patients at all, to participate. In various aspects, the system and/or method may include a device-enabled placebo or vitamin tablet that can be ingested by any individual under various circumstances: (1) ingested by itself; (2) co-ingested with medications that are not device-enabled to mark ingestion by a patient; (3) ingested at any time by a patient or any other consumer, etc.

For example, the Boston patient's physician switches him to a different HIV medication because of side effects and viral resistance issues, and that medication is not device-enabled to mark ingestion. The Boston patient feels a strong connection to the medmatch program, and has come to believe in the social good his adherence is creating. He is pleased when his pharmacist tells him that there is even a medmatch tablet without a medication, e.g., a device-enabled placebo, which enables him to continue his participation in the Nairobi donation program. The pharmaceutical company that manufactured his old medication is also pleased because they are able to continue their relationship with the Boston patient while they develop or acquire other device-enabled medications for their portfolio that will be suitable for him over time.

Another example is a non-patient consumer or advocacy group interested in using medmatch for a fundraising or support event. A group raising money for a cancer institute, for example, may link its annual cycling ride charity fundraiser to medmatch, where participants all train in the months leading up to the ride while using the system, and finish use once the race is completed. In this example, the fundraising ride of 2,000 individuals may have a daily training activity and placebo ingestions all linked to the matching donor giving that raises money for the charity. In a third example, a family care giver shows her support for a loved one living with a chronic illness by “matching” their drug adherence by taking a device-enabled placebo at the same times during the day that the loved one needs to take his or her medications. This aspect creates family support and also links family efforts to the medmatch cause that they have selected, so that the family group can see their cumulative support for their cause.

Further, product manufacturers may be able to enter into a greater number of more favorable arrangements with payors by including an altruistic element to their product marketing programs. The altruism may be applied to other members of the payor population, e.g. if a member ingests per prescribing guidelines, another member may get help with co-pays, or the payor gets a discount for himself or herself.

In various aspects, the system and method have design provisions that protect against and/or take predetermined protective action(s) upon the occurrence of various events, e.g., overuse by an individual; a possible situation where someone may try to do “more good” by taking more than a prescribed amount of their medication; sudden stoppage of medication usage by the donor resulting in stoppage of the donation medication to the donee, etc.

In one example of a protective action, the donation match will only occur if the individual takes the prescribed dose, no more and no less. In various aspects, this check may be performed in an automated fashion by software/processor by comparing stored data indicating the dosage amount and frequency of a prescribed medication against health promotion data communicated by a device associated with the prescribed medication, e.g., a device-enabled pill, syringe, inhaler, etc. that communicates dose, time of dose, type of dose at each delivery event. In another example, an independent third party may manage the medmatch donation program on behalf of a product manufacturer. In still another example, the system/method automatically monitor stoppage events and ensure predetermined actions are taken, e.g., the donee's medication supply continues uninterrupted on behalf of the pharmaceutical company, the donee is matched to a new donor, the donee's physician is notified by email, instant message, etc.

### System

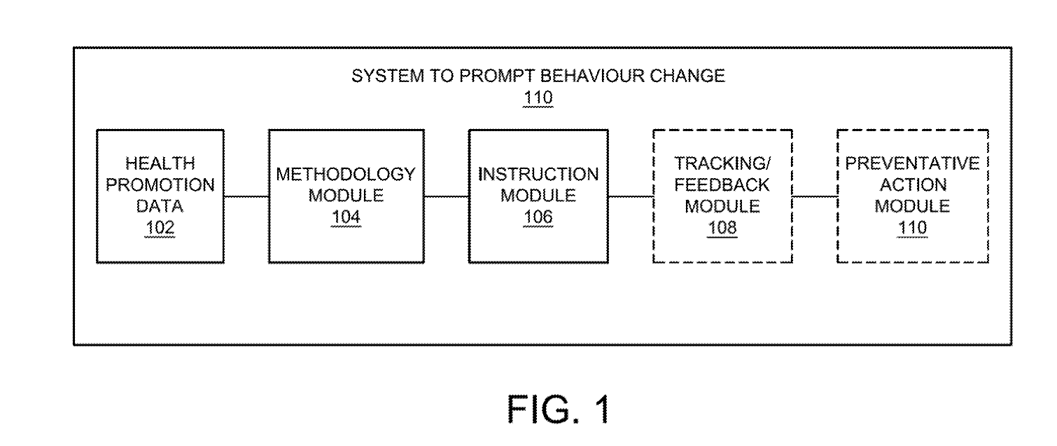

Referring now to FIG. 1, there is shown a schematic of a system 100 to prompt behavior change 100. The system 100 comprises health promotion data 102 generated and/or communicated from/to a device; a methodology module 104 associated with software/processor to identify at least one behavior change methodology associated with the health promotion data 102; and an instruction module 106 associated with the software/processor to initiate the identified at least one behavior change methodology. Optionally, and in various aspects, the system 100 also comprises a tracking/feedback module 108 which tracks and/or provides a feedback associated with the health promotion data 102, the behavior change methodology, the initiation of the behavior change methodology, etc. Optionally, and in various aspects, the system 100 further comprises a preventative action module 110 which initiates a preventative or other action.

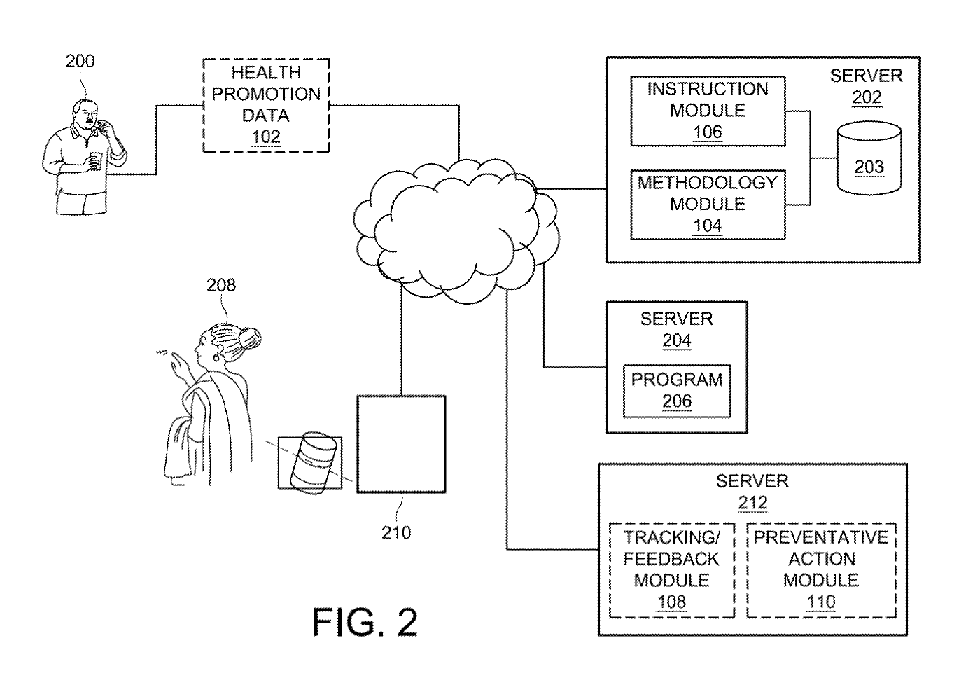

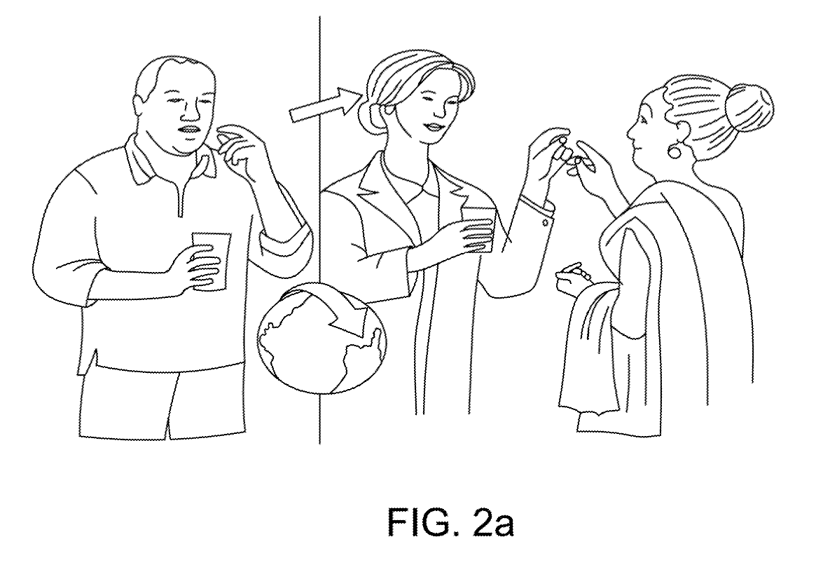

For example, and with reference to FIGS. 2 and 2a, where there are shown a system operation of the system to prompt behavior change 100 of FIG. 1 and one conceptualization of a medmatch methodology, respectively. With continuing reference to the foregoing medmatch methodology illustration, a Boston patient 200 ingests a device-enabled medication (not shown), which communicates the health promotion data 102 such as the time of ingestion and patient identification information to the patient's detector device (not shown). The detector device, for example, may be implemented as an on-body, adhesive communication patch (not shown). In this example, the detector device also collects health promotion data such as physiologic data, e.g., heart rate, heart variability, angle of repose, etc.

The detector device forwards the combined health promotion data 102 to the patient's mobile phone for onward communication to a hub, shown herein as first server 202, which includes the methodology module 104, the instruction module 106, and a database 203.

Various aspects include the server 202, or other such hub device. As used herein, the term hub includes any hardware device, software, and/or communications component(s), as well as systems, subsystems, and combinations of the same which generally function to communicate the health promotion data 102. Communication of the health promotion data 102 includes receiving, storing, manipulating, displaying, processing, and/or transmitting the health promotion data 102. In various aspects, the hub also functions to communicate, e.g., receive and transmit, non-health promotion data. Broad categories of the hub include, for example, base stations, personal communication devices, and mobile telephones. Examples of the hub and other devices are discussed in U.S. patent application Ser. No. 12/522,249 filed Jul. 2, 2009 entitled “INGESTIBLE EVENT MARKER DATA FRAMEWORK,” and published Jan. 13, 2011 as U.S. Patent Application Publication No. 2011/0009715.

The methodology module 104 processes the health promotion data 102 which includes an identifier for the Boston patient 200. Of note, the health promotion data 102, the methodology module 104, and/or other system components may use personal identifiers such as name, etc., anonymous identifiers such as assigned numbers, or other identifiers to determine whether the health promotion data 102 are associated with one or more methodologies. The methodology module 104 uses the identifier to compare with stored information in the database 203 to determine if the Boston patient 200 is a participant in one or more methodologies. In this example, the methodology module 104 processes the health promotion data 102 and identifies the data as associated with the Boston patient 202 and as a participant who has selected medmatch as his charitable giving program.

The instruction module 106 initiates, on a data system, shown herein as the second server 204, a program 206 to facilitate donation of a medication to a Nairobi patient 208. The program 206 may be, for example, one or more software applications which provide one or more functions necessary to administer a methodology, e.g., a donation. For example, a medmatch software application may interact with one or more networks of systems, systems, system components, and/or devices to provide information regarding updates on donations to recipients, e.g., identity of recipient, type of medication, date and method of delivery to recipient, pharmacy 210 providing medication, dosing instructions for recipient, manufacturers/donors responsible for the donations, etc.

In various aspects, one or more hubs store, manipulate, and/or forward, directly or indirectly, the health promotion data 102, alone or in combination with other data, to one or more data systems. The data systems include any hardware device, software, and/or communications component, as well as systems and subsystems of the same, which generally function to provide a service or activity related to the health promotion data 102, e.g., program 206 which provides instructions for the medmatch software application.

The example further includes a third server 212 having the tracking/feedback module 108 and the preventative action module 110. Acting independently of or interoperatively with one another, the tracking/feedback module 108 and preventative action module 110 receive data from any one or more variety of sources, e.g., the patient's mobile phone, the methodology module 104, the instruction module 106, the program 206, the pharmacy system 210, and/or other sources.

The tracking/feedback module 108 receives, collects, etc., data regarding individual donors, groups of donors, causes donated to, etc., and provides feedback relevant to one or more methodologies to networks, computers, devices, etc., associated with various interested parties, e.g., the donor, the manufacturer, and the recipient.

The preventative action module 110 receives, monitors, processes, etc., data regarding boundary conditions, events, etc. relevant to use of the system. One such category of data is the monitoring for proper ingestion of prescribed medication to avoid over-ingestion, under-ingestion, improper dosage times, etc. For example, the health promotion data 102 may include information regarding the type and dosage frequency of a particular medication. The preventative action module 110 may compare such data against data stored in the database 203 having dosage instructions for the Boston patient 200 and for the Nairobi patient 208. Upon identification of a discrepancy, the preventative action module may generate appropriate alerts, communications, etc., to the patient, to the health care provider(s), to the pharmacy 210, etc. to ensure dosing is brought back into conformance with or remains within prescribed regimens.

The health promotion data 102 include any and all data related to promoting, maintaining, establishing, improving, etc., the health of an individual. The health promotion data 102 explicitly includes data that are machine-compatible, e.g., capable of being generated by, read by, written to, stored on or within, communicated from or to, and/or processed by a tangible machine or machine component, e.g., automatable data. Examples of machines and machine components include networks of computers, computers, storage media, communication devices, processing devices, circuitry, etc., as may be now known or provided in the future. Examples of data content include user identification; type, manufacturer, amount, time, and mode of delivery of products, e.g., medications, placebos, vitamins, foodstuff, etc. Examples of mode of delivery include ingestion, injection, inhalation, infusion, transdermal, insertion, etc. Examples of devices that generate the health promotion data 102 include ingestible devices; intelligent syringes; intelligent IV bags; intelligent inhalers; intelligent infusers and catheters; data receivers and detectors, e.g., personal health companions; smart packaging, memory and reminder tools; blood pressure cuffs; scales, glucometers, exercise tools and devices, eating habit trackers, medical and hospital devices, and other health-promoting devices. Examples of smart syringes and injection events, for example, include those discussed in U.S. patent application Ser. No. 12/673,326 filed Feb. 12, 2010 entitled “BODY-ASSOCIATED RECEIVER AND METHOD,” which was published as U.S. Pat. No. 8,114,021 on Feb. 14, 2012. Examples of intelligent inhalers and inhalation events include those discuss in U.S. Provisional Patent Application No. 61/373,803 filed Aug. 13, 2010 entitled “SYSTEM AND METHOD FOR DELIVERY AND DETECTION OF AN INHALABLE DOSE”, infra. As used herein, the term “health-promoting devices” means any device, component, etc., capable of precise measurement of one or more health related parameters, e.g., heart rate, heart rate variability, angle of repose, accelerometer data, ingestion event, injection event, inhalation event, infusion event, drug depot release event, etc. This is in contrast to more subjectively-derived data such as patient-entered estimates of measurements, events as recorded by patients, etc.

Various aspects extend to non-medication and medication-like medical devices and monitoring products, where the adherence to a medical, health and wellbeing-related regimen can link a personal decision or choice to an altruistic goal and associated donation, show of support etc. For example, the wearing and/or use of a hearing aid, a pedometer, a weight scale, a blood pressure cuff, a blood glucose meter, etc., may all enable medmatch: any sensor-enabled measurement of personal decisions, choices and physiologic state, such as sensed parameters of heart rate, sleep, activity, respiration, diet and molecular parameters such as blood glucose, cholesterol, creatinine, etc., may be linked to medmatch. Another example is any assessment of food consumption and caloric intake enabling medmatch, where a target goal (such as lower caloric intake) drives the medmatch process. Another example is smoking cessation, where devices that demonstrate a decline in cigarettes or related products being consumed enable medmatch to make donations for every product not consumed by the individual.

Examples of the foregoing devices include, but are not limited to, those described in:

U.S. patent application Ser. No. 11/912,475 filed Jun. 23, 2008 entitled “PHARMA-INFORMATICS SYSTEM,” which was published Nov. 20, 2008 as U.S. Patent Application Publication No. 2008/0284599, U.S. patent application Ser. No. 12/404,184 filed Mar. 13, 2009 entitled, “PHARMA-INFORMATICS SYSTEM,” which was published on Sep. 10, 2009 as U.S. Patent Application Publication No. 2009/0227404, U.S. patent application Ser. No. 12/522,249 filed Jul. 2, 2009 entitled “INGESTIBLE EVENT MARKER DATA FRAMEWORK,” which was published as U.S. Patent Application Publication No. 2011/0009715, U.S. patent application Ser. No. 12/741,583 filed on May 5, 2010 and entitled “HIGH-THROUGHPUT PRODUCTION OF INGESTIBLE EVENT MARKERS,” which was published Jan. 19, 2012 as U.S. Patent Application Publication No. 2012/0011699, a PCT Patent Application No. PCT/US10/34186 filed on May 10, 2010 and entitled “INGESTIBLE EVENT MARKERS COMPRISING AN IDENTIFIER AND AN INGESTIBLE COMPONENT,” which was published Nov. 18, 2010 as WO 2010/132,331, U.S. patent application Ser. No. 12/238,345 entitled, “IN-BODY DEVICE WITH VIRTUAL DIPOLE SIGNAL AMPLIFICATION” filed Sep. 25, 2008, which was published on Mar. 26, 2009 as U.S. Patent Application Publication No. 2009/0,082,645, U.S. patent application Ser. No. 12/744,642 filed on Apr. 27, 2010 and entitled “HIGHLY RELIABLE INGESTIBLE EVENT MARKERS AND METHODS OF USING SAME,” which was published Mar. 3, 2011 as U.S. Patent Application Publication No. 2011/0,054,265, U.S. patent application Ser. No. 12/238,345 filed Sep. 25, 2008 and entitled “IN-BODY DEVICE WITH VIRTUAL DIPOLE SIGNAL AMPLIFICATION,” which was published Mar. 26, 2009 as U.S. Patent Application Publication No. 2009/0,082,645, U.S. patent application Ser. No. 12/564,017 filed Sep. 21, 2009 entitled “COMMUNICATION SYSTEM WITH PARTIAL POWER SOURCE,” which was published Jul. 12, 2011 as U.S. Pat. No. 7,978,064, U.S. patent application Ser. No. 12/673,326 filed Feb. 12, 2010 entitled “BODY-ASSOCIATED RECEIVER AND METHOD,” which was published Feb. 14, 2012 as U.S. Pat. No. 8,114,021, PCT application serial no. PCT/US2007/082563 entitled “CONTROLLED ACTIVATION INGESTIBLE IDENTIFIER,” which was published May 2, 2008 as PCT Application Publication No. WO 2008/052,136, PCT application serial No. PCT/US2007/024225 entitled “ACTIVE SIGNAL PROCESSING PERSONAL HEALTH SIGNAL RECEIVERS,” which was published May 29, 2008 as PCT Application Publication No. WO 2008/063,626, PCT application serial no. PCT/US2007/022257 entitled “LOW VOLTAGE OSCILLATOR FOR MEDICAL DEVICES,” which was published Jun. 5, 2008 as PCT Application Publication No. WO 2008/066,617, PCT application serial no. PCT/US2008/052845 entitled “INGESTIBLE EVENT MARKER SYSTEMS,” which was published Aug. 7, 2008 as PCT Application Publication No. WO 2008/095,183, PCT application serial no. PCT/US2008/053999 entitled “IN-BODY POWER SOURCE HAVING HIGH SURFACE AREA ELECTRODE,” which was published Aug. 21, 2008 as PCT Application Publication No. WO 2008/101.107, PCT application serial no. PCT/US2008/056296 entitled “IN-BODY POWER SOURCE HAVING MULTI-DIRECTIONAL TRANSMITTER,” which was published Sep. 18, 2008 as PCT Application Publication No. WO 2008/112,577, PCT application serial no. PCT/US2008/056299 entitled “IN-BODY POWER SOURCE HAVING DEPOLYABLE ANTENNA,” and PCT application serial no. PCT/US2008/077753 entitled “IN-BODY DEVICE WITH VIRTUAL DIPOLE SIGNAL AMPLIFICATION,” which was published Apr. 2, 2009 as WO 2009/042,812; the disclosures of which applications are herein incorporated by reference, U.S. patent application Ser. No. 11/912,475 filed Apr. 28, 2006 entitled “PHARMA-INFORMATICS SYSTEM”, which was published Nov. 20, 2008 as U.S. Patent Application Publication No. 2008/0,284,599, U.S. patent application Ser. No. 12/522,249 filed Jul. 2, 2009 entitled “INGESTIBLE EVENT MARKER DATA FRAMEWORK”, which was published Jan. 13, 2011 as U.S. Patent Application Publication No. 2011/0,009,715, U.S. patent application Ser. No. 12/349,453 filed Jan. 6, 2009 entitled “SMART PARENTERAL ADMINISTRATION SYSTEM,” which was published as U.S. Patent Application Publication No. 2009/0,118,594, U.S. patent application Ser. No. 12/776,480 filed Jul. 11, 2007 entitled “ACOUSTIC PHARMA-INFORMATICS SYSTEM,” which was published as U.S. Patent Application Publication No. 2011/0,063,957, and U.S. Provisional Patent Application No. 61/373,803 filed Aug. 13, 2010 entitled “SYSTEM AND METHOD FOR DELIVERY AND DETECTION OF AN INHALABLE DOSE”. Each of the foregoing is incorporated by reference in its entirety.

The methodology module 104 and the instruction module 106 include any implementation of software, hardware, firmware or combinations of the foregoing, whether standalone, integrated with other modules or multiple devices, etc., so long as the modules are capable of carrying out the functions described herein. Either or both of the modules may be associated with, e.g., may be resident on, executable by, displayable by, etc., a component, a device, a computer, a network or networks of communicating devices, etc.

The behavior change methodologies include many and varied methodologies. In addition to the illustrated MEDMATCH methodology, examples include RACES WITHIN REACH methodology; PICK A DESKTOP WIDGET/AVATAR methodology; FAMILY RESPONSIBILITY methodology; VIRTUAL MANSION methodology; DAILY HATCH methodology; FITIMALS methodology; DELIGHTFUL COMPARATORS methodology; ADHERE TO WIN methodology; THE SHAME GAME methodology; PLEDGE MATCHING methodology; HELP FROM MY FRIENDS methodology; LOVE BUZZ methodology; PATCH ALERTS methodology; DONE! BUZZ methodology; PLUG methodology; REAL PATIENT PROFILES methodology; MOOD MINER methodology; HEART FIT methodology; THE SWIMMER PATCH methodology; SMALL STEPS TO BIG RESULTS methodology; COMMIT TO HEALTHY EATING methodology; and MATCHED methodology. The foregoing non-exhaustive list is provided as an illustration of some of the variety and versatility of the system, and not as a limitation thereof. Each of the methodologies is described in detail hereinafter.

Races within Reach Methodology

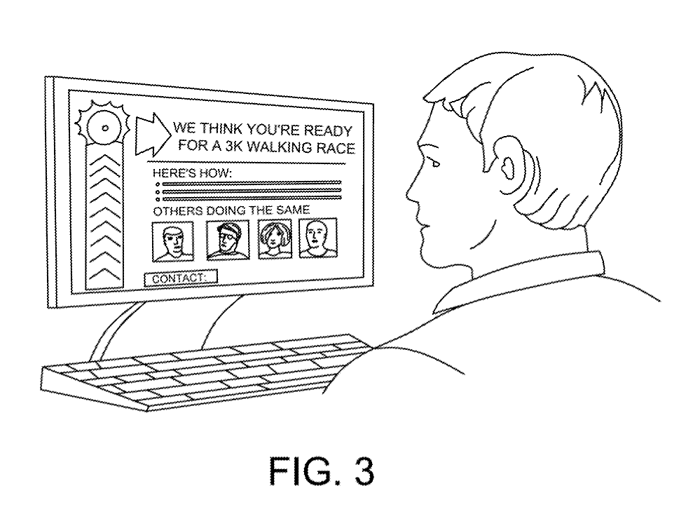

The races within reach methodology, as conceptually illustrated in FIG. 3, may prompt behavior change by encouraging the user with suggestions of participation in various organized fitness events. As the user's fitness improves, the system suggests fitness events appropriate for their abilities and provides training guidance as the event approaches. Additionally, other people training for the same event at a similar performance level can be connected for group training or support. Placing new fitness activities in the path of users creates fitness nudges that are further strengthened by connecting groups of participants matched according to capabilities.

Examples of implementation include a participant providing information about his abilities (the health promotion data 102) to a website associated with the methodology module 104. The methodology module 104 may process the health promotion data 102 to identify the corresponding races within reach methodology. The instruction module 106 may initiate an instruction whereby program(s) and associated system(s) analyze the participant's abilities, select fitness events and the like based on the analyzed abilities, and make the event information accessible by the user, e.g., display results, updates, etc., on a display device.

Pick a Desktop Widget/Avatar Methodology

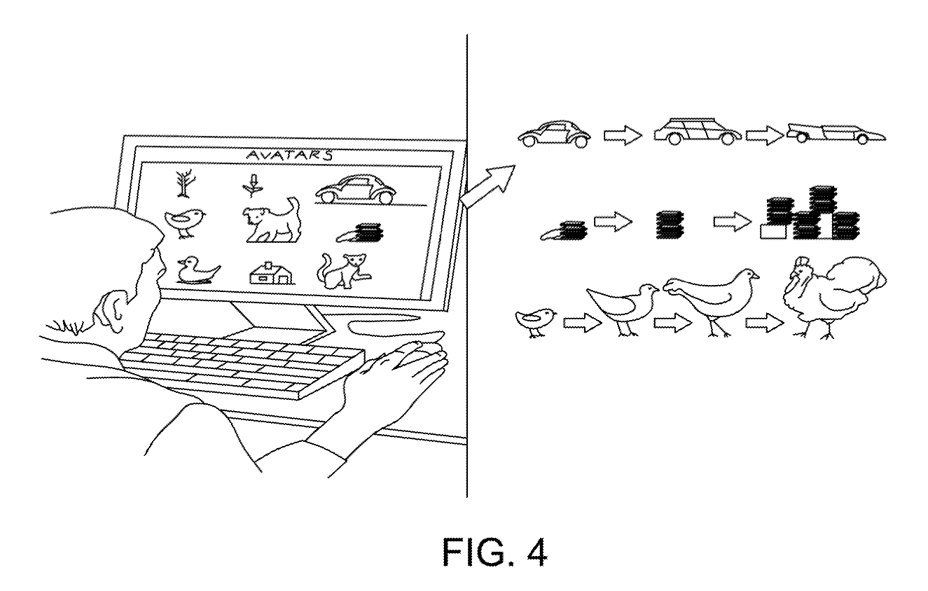

The pick a desktop widget/avatar methodology, as conceptually illustrated in FIG. 4, may provide a virtual representation of the status of each member of a family, based on their adherence to an exercise program, medication regimen, sleep schedule, or composite and displayed on their smart phone or computer desktop, etc. The user chooses which avatar they wish to represent their status and as it changes (with exercise, adherence, etc.), the avatar morphs to visually reflect this change. The avatars may create a visible mental model for states and changes that are invisible. The ability to select an avatar that is meaningful to the user creates relevance.

Examples of implementation include participants selecting avatars displayed by a software application. The selected avatars and corresponding participant information regarding exercise, adherence, etc. (the health promotion data 102) are communicated to a website associated with the methodology module 104. The methodology module 104 may process the health promotion data 102 to identify corresponding pick a desktop widget/avatar methodology. The instruction module 106 may initiate an instruction whereby program(s) and associated system(s) analyzes status changes and updates avatars to morph accordingly.

Family Responsibility Methodology

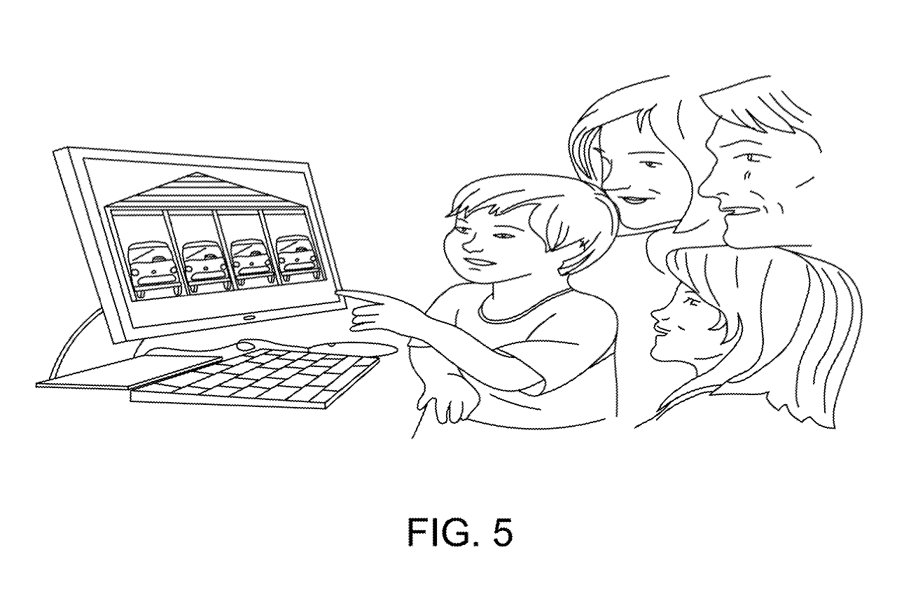

The family responsibility methodology, as conceptually illustrated in FIG. 5, provides a virtual representation of the status of each member of a family, based on their adherence to an exercise program, medication regimen, sleep schedule, composite, etc., and displayed, for example, on their smart phone or computer desktop. Each member of the family, for example, is represented by their own avatar, all linked by a common theme (such as multiple cars in a garage). The avatars visually morph to reflect changes in exercise, adherence, etc. and everyone participating can see the avatars of the others. The visibility of each other's avatars provides strong social reinforcers that motivate adherence. Game-like progression maintains interest, which becomes yet another reason for adherence and establishes new behavioral norms.

Examples of implementation include selection of avatars, e.g., each reflective of a common them, as displayed by a software application and generation of medication regimen data (the health promotion data 102). The selected avatars and corresponding health promotion data 102 are communicated to a website associated with the methodology module 104. The methodology module 104 may process the health promotion data 102 to identify the corresponding family responsibility methodology. The instruction module 106 may initiate an instruction whereby program(s) and associated system(s) generate game applications, etc. displaying representations of relative adherence, progression, etc. by visual changes to the selected avatars.

Virtual Mansion Methodology

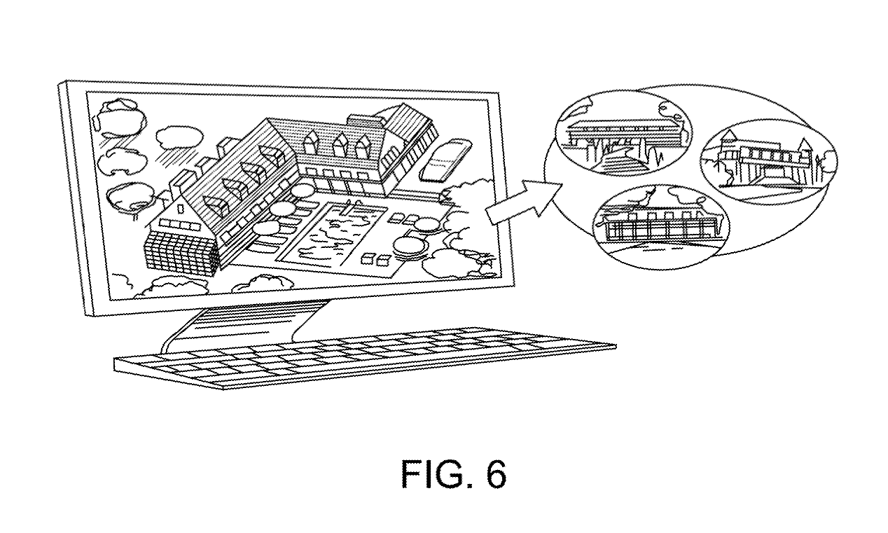

The virtual mansion methodology, as conceptually illustrated in FIG. 6, is an online, virtual representation of a group of people where each one is represented by an object in an online virtual mansion. As each person's status changes, e.g., through exercise, adherence, etc., their selected objects morph to reflect the real-life change by becoming more or less opulent, clean, etc. By helping to support other members of the mansion, the mansion itself may gain new features or compete with other mansions in the virtual neighborhood. Rolling several avatars into one community increases members' sense of responsibility to “do their part” to maintain and improve community health. Competition among communities further magnifies adherence.

Examples of implementation include generation of the health promotion data 102. The health promotion data 102 are communicated to a website associated with the methodology module 104. The methodology module 104 may process the health promotion data 102 to identify the corresponding virtual mansion methodology. The instruction module 106 may initiate an instruction whereby program(s) and associated system(s) generate software options for the persons to select mansion attributes and other indicia pertinent to the virtual mansion. The software program may further correlate the updates of the health promotion data 102 with predetermined relative changes to the mansion attributes, and display such changes.

Daily Hatch Methodology

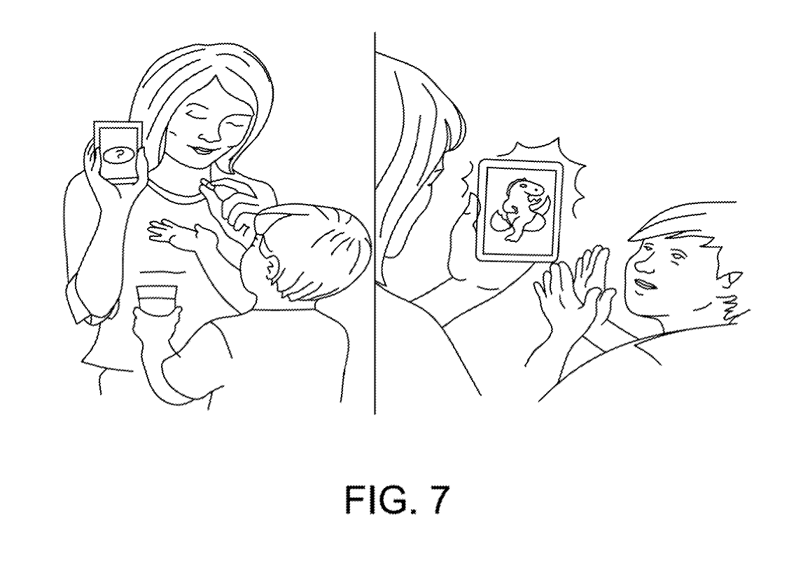

The daily hatch methodology, as conceptually illustrated in FIG. 7, provides an application, e.g., a computer or smart-phone application, which generates an enticement for children (or others) to engage with their medication. The application shows a delightful result when a child takes their medication. The result, for example, may display as a dinosaur hatching from an egg, a seashell opening up, etc. The anticipation about which animal will emerge shifts focus from an unpleasant dosing moment to delightful play.

Examples of implementation include generation of a medication delivery event, e.g., the health promotion data 102. The health promotion data 102 are communicated to a website associated with the methodology module 104. The methodology module 104 may process the health promotion data 102 to identify the corresponding daily hatch methodology. The instruction module 106 may initiate an instruction whereby program(s) and associated system(s) identify predetermined health promotion events and generate software outputs relative to the event, e.g., display of a dinosaur hatching.

Fitimals Methodology

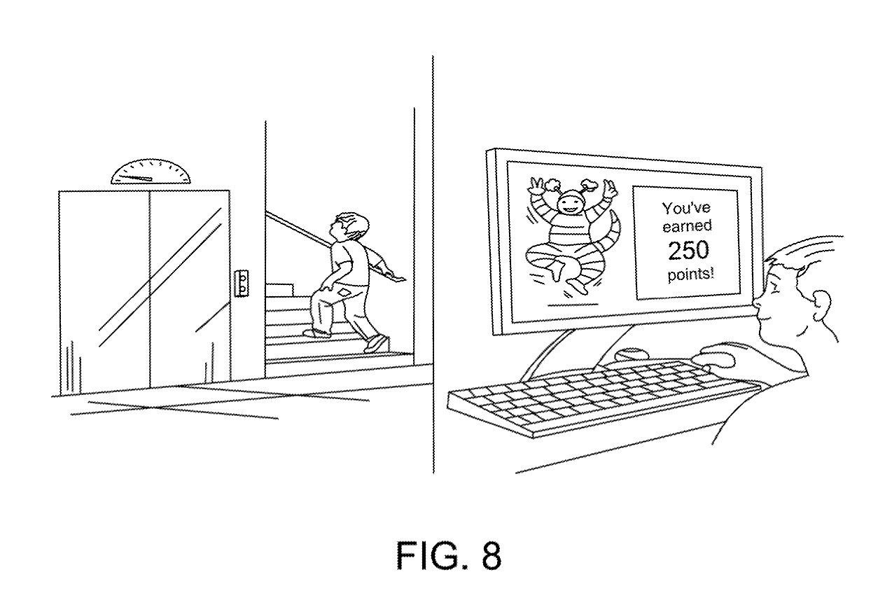

The fitimals methodology, as conceptually illustrated in FIG. 8, provides a virtual game world that reflects and responds to real-world logged events. A real world action such as fitness, medication adherence, etc, builds a virtual character's abilities and progresses them through a narrative. Tying characters' abilities and powers in an engaging virtual world to real life actions provides new incentives to make better choices in the real world.

Similarly, methodologies may include a “gamefit” model. The gamefit methodology may include, for example, games that attract and entertain a user. In some aspects, the game keeps rewarding the user; shows the user's progress; permits the user to become deeply involved with the game. To get the user through challenging times, for example, the gamefit methodology keeps challenging the user to continue and provides new ways for the user to interact with others.

Examples of implementation include generation of the health promotion data 102. The health promotion data 102 are communicated to a website associated with the methodology module 104. The methodology module 104 may process the health promotion data 102 to identify the corresponding fitimals methodology. The instruction module 106 may initiate an instruction whereby program(s) and associated system(s) identify predetermined health promotion events, generates and builds a virtual character's abilities, and displays the character in conjunction with a predetermined narrative.

Delightful Comparators Methodology

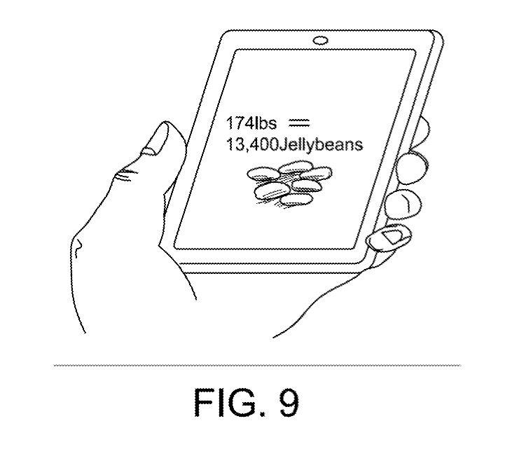

The delightful comparators methodology, as conceptually illustrated in FIG. 9, provides a scale that measures body weight without using pounds and kilograms. Weight is displayed in unique and delightful units such as jellybeans, billiard balls, blueberries, etc. Trying to lose weight may be a frustrating and slow process full of guilt and fear of failure. The dread of the weighing moment is lightened by including humorous and surprising units for weight. Additionally, prompting with smaller units (such as jellybeans) allows for more visible changes in weight.

Examples of implementation include generation of the health promotion data 102, e.g., an individual's weight. The health promotion data 102 are communicated to a website associated with the methodology module 104. The methodology module 104 may process the health promotion data 102 to identify the corresponding delightful comparators methodology. The instruction module 106 may initiate an instruction whereby program(s) and associated system(s) identify predetermined health promotion events such as weight changes; generates the corresponding change in the humorous and surprising units; and displays the traditional units, the humorous and surprising units, and visual indicia of the surprising units.

Adhere to Win Methodology

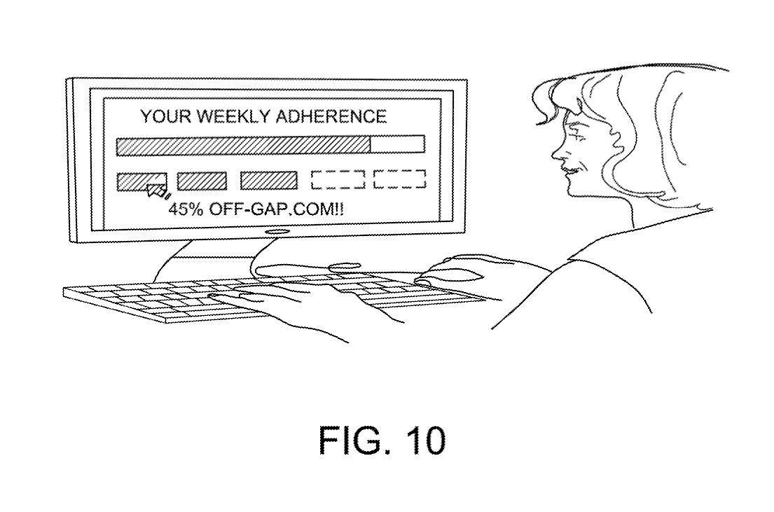

The adhere to win methodology, as conceptually illustrated in FIG. 10, provides desirable incentives for continued adherence in the form of prizes that users can win. High levels of adherence (to medication, exercise regimen, etc.) are rewarded with an increased number of chances to win discounts and prizes from personally relevant categories, for oneself or one's family. The perceived chance of winning motivates adherence. Additionally, prizes desired by family members add social pressure to further adhere.

Examples of implementation include generation of the health promotion data 102, e.g., medication event data, exercise data, etc. The health promotion data 102 are communicated to a website associated with the methodology module 104. The methodology module 104 may process the health promotion data 102 to identify the corresponding adhere to win methodology. The instruction module 106 may initiate an instruction whereby program(s) and associated system(s) identify predetermined health promotion events qualifying for prizes and facilitate award of the prizes, e.g., by providing award details, total award information, update of other family awards, etc.

The Shame Game Methodology

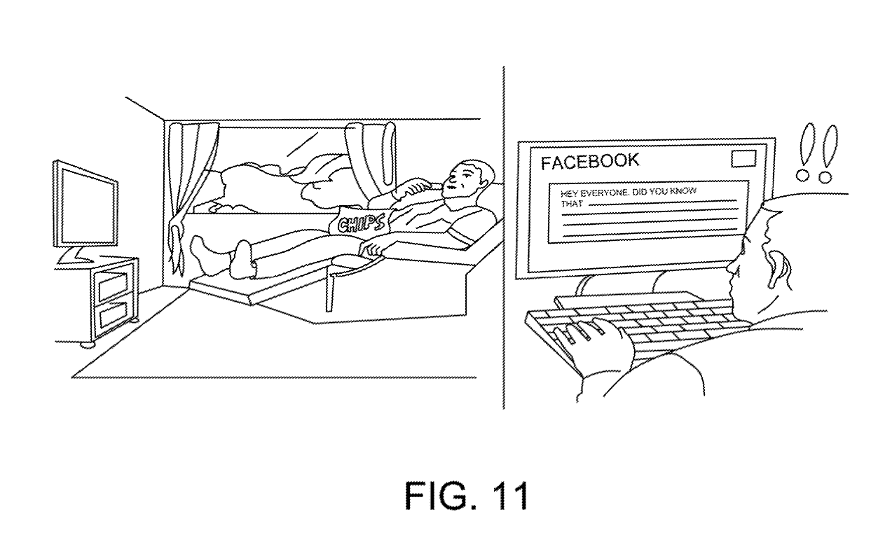

The shame game methodology, as conceptually illustrated in FIG. 11, provides an online program which uses social pressure to help a group of friends or family stick to their fitness or medication adherence goals. On sign up, all participants enter embarrassing information into the system about other members. Participants are enticed to stick to their goals with the knowledge that a lapse (after a warning, for example) will result in one of the embarrassing facts about them being posted to a social website, e.g., Facebook™. Desire to avoid public shame may be a powerful motivator.

Examples of implementation include generation of the health promotion data 102, e.g., medication event data, exercise data, etc. The health promotion data 102 are communicated to a website associated with the methodology module 104. The methodology module 104 may process the health promotion data 102 to identify the corresponding shame game methodology. The instruction module 106 may initiate an instruction whereby program(s) and associated system(s) identify predetermined health promotion events indicating nonconformance, generate a warning by text, email, etc. and, upon a second nonconformance event, post the previously store embarrassing-fact data to Facebook™.

Pledge Matching Methodology

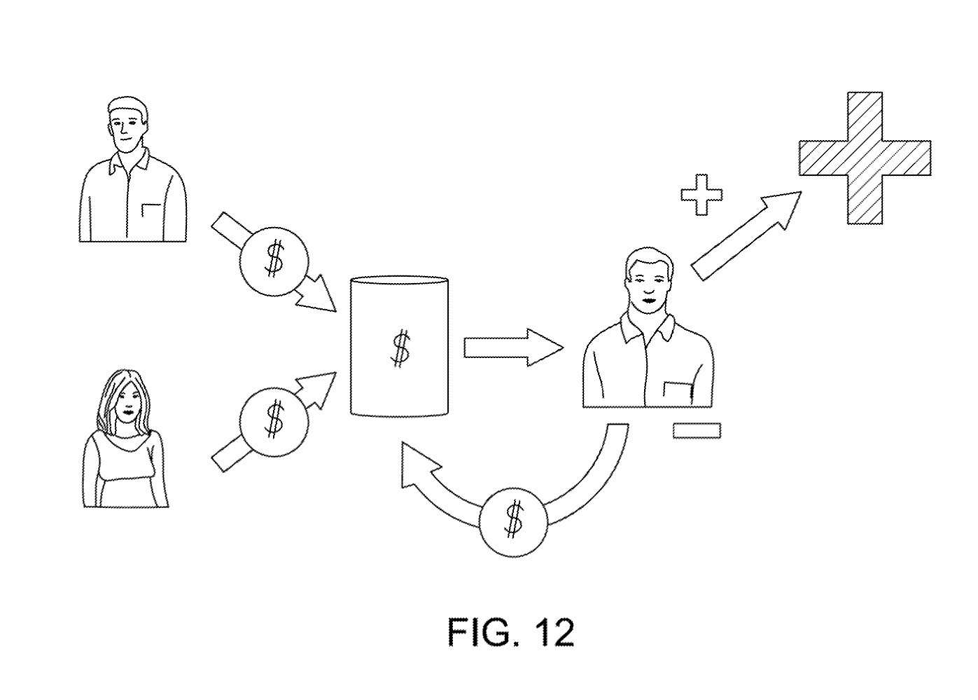

The pledge matching methodology, as conceptually illustrated in FIG. 12, provides a support program that uses pledge(d) money from friends or family as an enticement for an individual to stick to their fitness or medication adherence goals. A charity is chosen by the main participant and pledge contributions are made through the system. After the goal period has elapsed, the actual contribution to the selected charity may be calculated and provided via various means, e.g., the pledge may range from $0 (in the case of total non-adherence) to twice the pledged amount (in the case of total adherence). The matching funds may come from the general pledge pool, insurance company contributions, etc. Pledges create a public commitment to follow-through. Both the possibility of doubling one's donation and the prospect of “falling short” of one's goals further reinforces adherence.

Examples of implementation include generation of the health promotion data 102, e.g., medication event data, exercise data, etc. The health promotion data 102 are communicated to a website associated with the methodology module 104. The methodology module 104 may process the health promotion data 102 to identify the corresponding pledge matching methodology. The instruction module 106 may initiate an instruction whereby program(s) and associated system(s) identify predetermined health promotion events indicating adherence and nonconformance events, calculate a total donations based on predetermined rules and the actual health promotion data 102, update adherence and pledge outcomes on various systems, and link in/communicated with preexisting pledge program systems to provide pledge data to such systems.

Help from My Friends Methodology

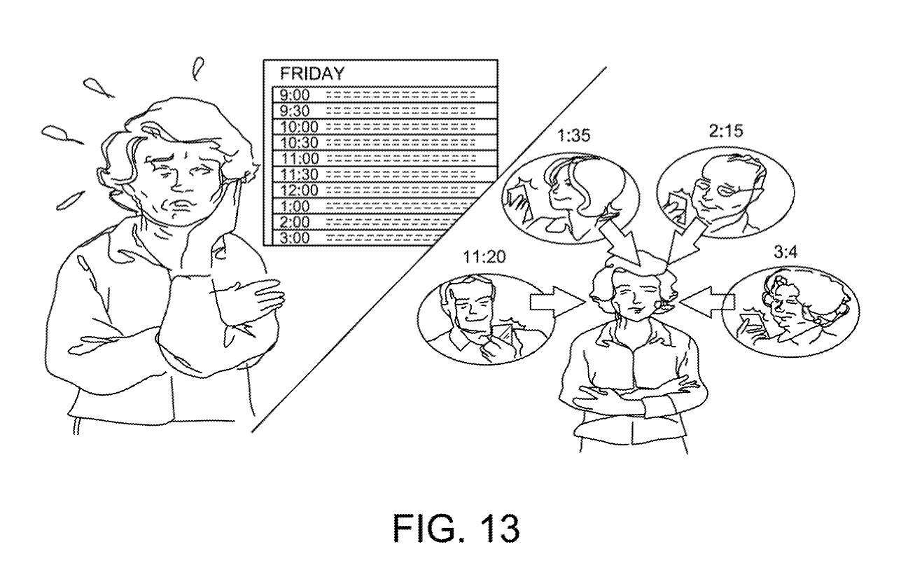

The help from my friends methodology, as conceptually illustrated in FIG. 13, provides a system that facilitates the engagement of support from an individual's personal network by, for example, taking medication with an ingestible device that marks the ingestion event. If the individual feels that they need (or might need) support, the user swallows a pill that alerts their designated network to this fact through texts, Facebook™ alerts, etc. Their friends/family are then able to provide help, encouragements, or empathy. The automatic and effortless activation of a support network by ingesting an event marker helps individuals navigate through adherence rough spots and potentially prevents slipping.

Examples of implementation include generation of the health promotion data 102, e.g., medication event data. The health promotion data 102 are communicated to a website associated with the methodology module 104. The methodology module 104 may process the health promotion data 102 to identify the corresponding help from my friends methodology. The instruction module 106 may initiate an instruction whereby program(s) and associated system(s) generate meaningful alerts, messages, etc.

Love Buzz Methodology

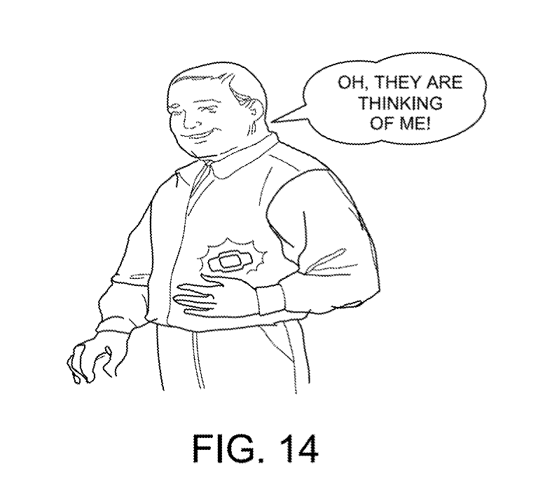

The love buzz methodology, as conceptually illustrated in FIG. 14, provides a vibration-enabled detector such as an adhesive communication device that privately signals that another is thinking about you. A user's loved ones are able to send a buzz as a signal that they are thinking of the user. Through the use of vibration patterns, the buzz may indicate different senders and multiple messages, e.g. Morse code. A buzz is like a remote hug from loved ones, sending a caring signal at unexpected moments that creates an emotional connection to the patch.

Examples of implementation include generation of the health promotion data 102, e.g., loved one's data. The health promotion data 102 are communicated to a website associated with the methodology module 104. The methodology module 104 may process the health promotion data 102 to identify the corresponding love buzz methodology. The instruction module 106 may initiate an instruction whereby program(s) and associated system(s) generate vibratory or other messages, e.g., blinking lights, on the recipient's detector. Examples of a detector include those discussed in U.S. patent application Ser. No. 12/673,326 filed Feb. 12, 2010 entitled “BODY-ASSOCIATED RECEIVER AND METHOD,” which was published Feb. 14, 2012 as U.S. Pat. No. 8,114,021.

Patch Alerts Methodology

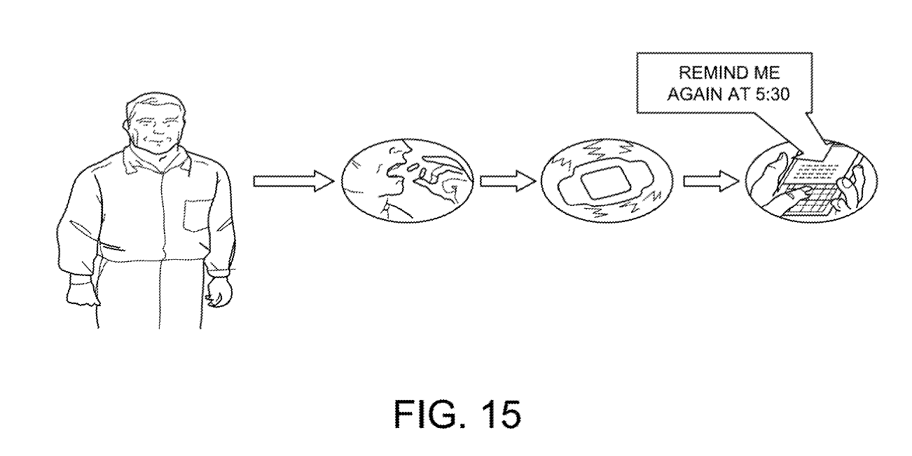

The patch alerts methodology, as conceptually illustrated in FIG. 15, utilizes a vibration-enabled detector, e.g., adhesive patch, to privately alert the user that she forgot to take her medication. The patch vibrates to let the user know that she forgot to take their medication. Should she be away from the medication, she can reset a reminder function. Reminders from the patch create trust that the patch is working in addition to aiding adherence and from the user's perspective gives the patch a meaningful role, alone or in addition to other detector functionality.

Similarly, a “patch communicator” methodology may coach a user in real time and enhance the value of the patch. Other inclusions in this methodology include, for example, generating alerts based on short-term successes to reinforce the user's actions and help the user to remember. The patch communications, e.g., audio, visual, tactile, etc., may constantly reinforces healthy choices and enable the user to track their behavior.

Examples of implementation include generation of the health promotion data 102, e.g., data generated by a software program associated with ingestion event data that identifies failure to receive data indicating on on-schedule ingestion event. The health promotion data 102 are communicated to a website associated with the methodology module 104. The methodology module 104 may process the health promotion data 102 to identify the corresponding patch alerts methodology. The instruction module 106 may initiate an instruction whereby program(s) and associated system(s) generate vibratory or other messages, e.g., blinking lights, on the recipient's detector, indicating that the user may want to determine if a dose has been missed.

Done! Buzz Methodology

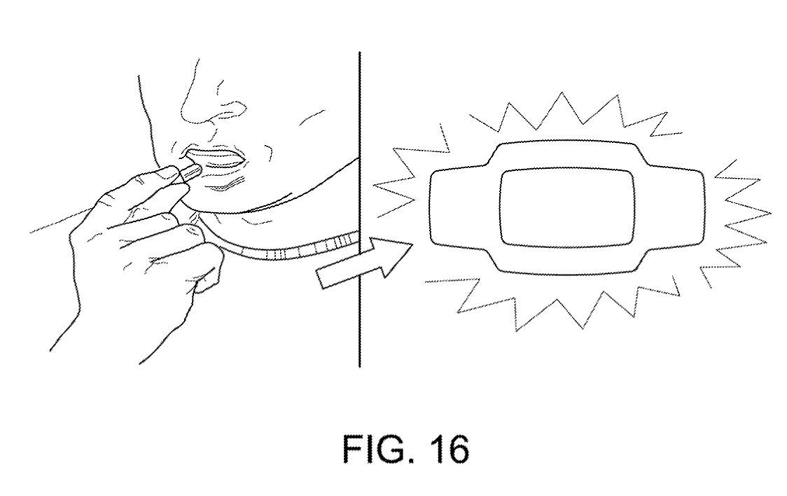

The done! buzz methodology, as conceptually illustrated in FIG. 16, provides a vibration-enabled detector, e.g., adhesive patch, to privately confirm to the user that the medication was swallowed. Upon ingestion of a medication, the system provides the user with feedback that the medication has been registered, building trust in the technology. Receiving a buzz when the pill is registered may satisfy the user's craving for certainty that the system is working and gives the patch a(nother) meaningful role in the system.

Examples of implementation include generation of the health promotion data 102, e.g., ingestion event data. The health promotion data 102 are communicated to a processor associated with the methodology module 104. The methodology module 104 may process the health promotion data 102 to identify the corresponding done! Buzz methodology. The instruction module 106 may initiate an instruction whereby program(s) and associated system(s) generate vibratory or other messages, e.g., blinking lights, on the recipient's detector.

Plug Methodology

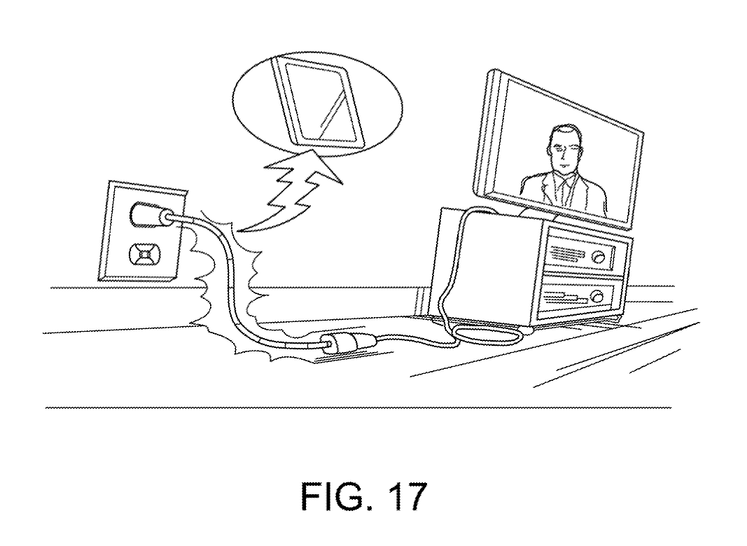

The plug methodology, as conceptually illustrated in FIG. 17, provides a smart outlet that enables the system to toggle power to and monitor usage of various small appliances. The user chooses an appliance (such as a coffee maker, TV, or video game system) to connect to the smart outlet and selects usage thresholds, e.g., 100% adherence yields ten weekly hours of TV. Levels of adherence, exercise, etc. logged by the system determines how much time the user can spend with the selected appliance. In various aspects, the smart outlet may also function as a base station or hub. Self-imposed “handcuffs” that prevent access to an electronic device provide a powerful incentive to adhere. This may turn long-term, decoupled effects of not adhering into current consequences.

Examples of implementation include generation of the health promotion data 102, e.g., ingest event data. The health promotion data 102 are communicated to a hub associated with the methodology module 104. The methodology module 104 may process the health promotion data 102 to identify the corresponding plug methodology. The instruction module 106 may initiate an instruction whereby program(s) and associated system(s) monitor and control access to the selected appliances according to the preselected conditions.

Real Patient Profiles Methodology

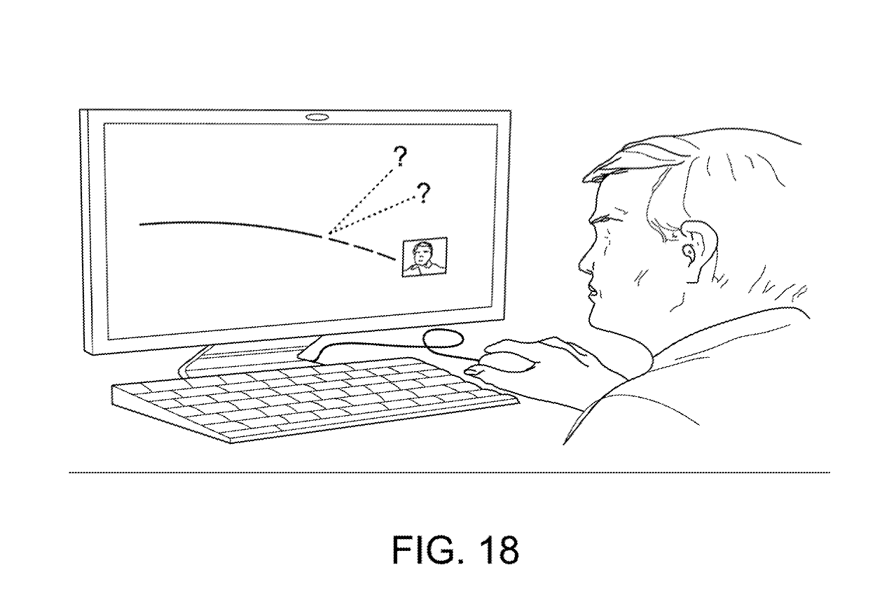

The real patient profiles methodology, as conceptually illustrated in FIG. 18, provides an element of feedback to an individual's treatment/regimen for conditions that might otherwise have long feedback loops or none at all. Current actions are forecasted based on physiology and adherence, showing the user a real (and perhaps curated) profile of somebody who once was where the user currently is. For predictions that might be discouraging, the system provides suggestions on behavior and alternative inspirational profiles. Predicting the individual's future health states using real patient profiles creates a visceral connection between today's actions and tomorrow's outcomes and, therefore, more persuasive reasons to change one's actions.

Similarly, a “real futures” methodology may give a vicarious view of a user's potential future. For example, the methodology may entice a user to take control of his/her future by prompting the user with tips from a similarly-situated person. In this manner, the user is permitted to receive support and encouragement through objective data and is shown a possible change of trajectory to fuel the user's confidence.

Examples of implementation include generation of the health promotion data 102, e.g., disease condition, level of treatment, duration of treatment, etc. The health promotion data 102 are communicated to a website associated with the methodology module 104. The methodology module 104 may process the health promotion data 102 to identify the corresponding real patient profiles methodology. The instruction module 106 may initiate an instruction whereby program(s) and associated system(s) generate suggestions, alternative inspirational profiles, etc.

Mood Miner Methodology

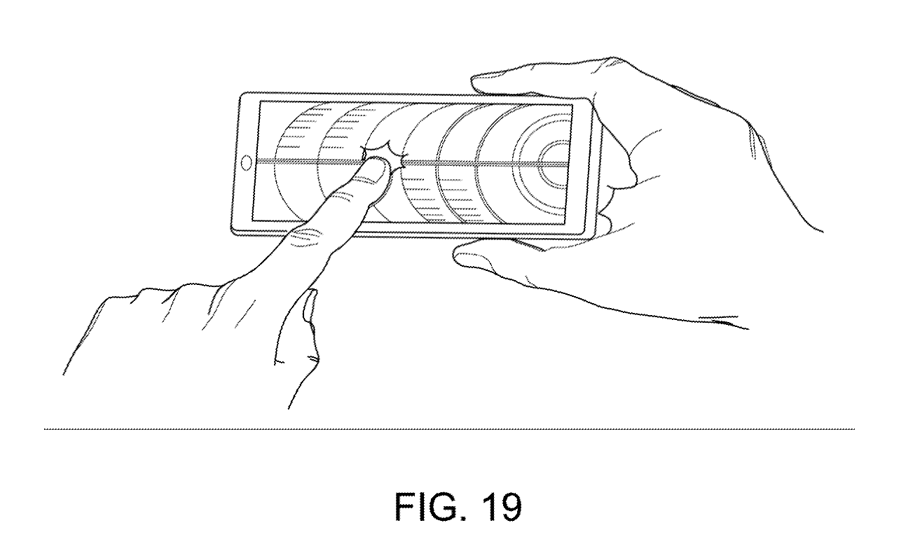

The mood miner methodology, as illustrated in FIG. 19, provides a system that collects objective measures as well as subjective inputs in a convenient way. Mood miner methodology identifies patterns and relationships between one's exercise, sleep, and medicine adherence with subjective inputs, making visible the relationships between them and making behavioral choices more relevant. Comparing longitudinal subjective input with objective body measures reveals surprising patterns that help correct intuitive theories about why the user feels the way she/he does. Adjusting the user's theories allows for stronger intrinsic motivators for better behavior.

Examples of implementation include generation of the health promotion data 102, e.g., sleep data, medication ingestion data, and exercise data and subjective data. Subjective data generation may be accomplished via various methods. In one example, an application on the user's mobile phone displays concentric rings of varying colors. Each color is representative of the user's relative feelings, emotions, self-assessment, etc. The user selects the color(s) pertinent to the conditions and the application generates the subjective data. The health promotion data 102 are communicated to the user's phone application, which has an associated methodology module 104. The methodology module 104 may process the data to identify the corresponding mood miner methodology. The instruction module 106 may initiate an instruction whereby program(s) and associated system(s) analyze the data for patterns and meaningfully display the patterns, related insights, etc.

Heart Fit Methodology

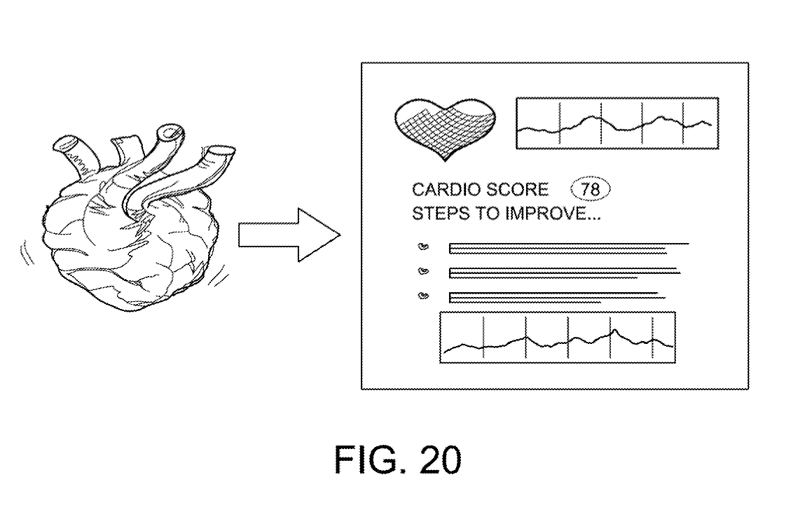

The heart fit methodology, as conceptually illustrated in FIG. 20, provides a system that focuses on heart metrics rather than analogs such as step counts for fitness or health goals. Using data such as resting heart rate and time spent above target heart rate, this system can provide information and guidance on fitness and daily exercise that span across activity. Also, the tracking of validated cardiovascular fitness metrics such as heart rate variability and heart rate time to recovery might provide insights for cardiology care. Many popular fitness tracking systems cannot measure reliable, long-term heart rate, which is arguably one of the most important measures of fitness. Moreover, increased insight into heart rate allows for richer fitness encouragement through a new set of metrics, e.g., other than traditional proxies for fitness such as weight, BMI, or exercise.

Examples of implementation include generation of the health promotion data 102, e.g., heart rate, heart rate variability, fitness activity and resting data, etc. The health promotion data 102 are communicated to a server associated with the methodology module 104. The methodology module 104 may process the health promotion data 102 to identify the corresponding heart fit methodology. The instruction module 106 may initiate an instruction whereby program(s) and associated system(s) integrate data streams, fuse data to generate a refined cardiac (or other) health models, and infer treatment/regimen optimization steps, etc.

Swimmer Patch Methodology

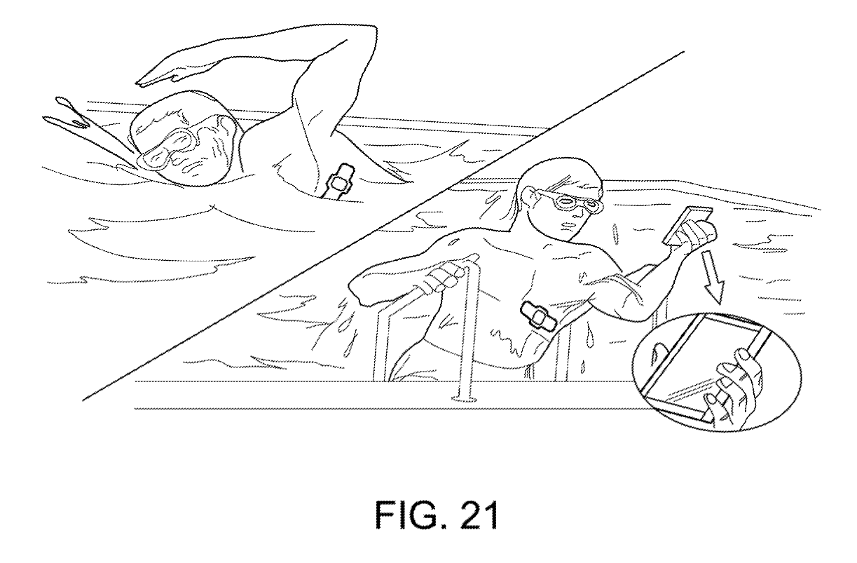

The swimmer patch methodology, as conceptually illustrated in FIG. 21, provides a system that focuses on heart metrics rather than analogs such as step counts for fitness or health goals. By monitoring heart rate in real time, the patch vibrates to alert the swimmer that they have reached their target heart rate, allowing optimal training or exercise. Additionally, by using accelerometer data, the system becomes a lap counter. This may also offer novel real-time tracking capabilities to swimmers across all ability levels. In terms of prompting behavior change, it is noted that this term is used broadly and includes concept(s) such as facilitating training and goal achievement. For example, the prompt to change behavior in using the swimmer patch may include delivery of data that prompt the swimmer to adhere to training regimens more closely, resulting in achievement of various swimming and training goals. A skilled artisan will recognize that multiple concepts apply.

Examples of implementation include generation of the health promotion data 102, e.g., heart rate, accelerometer data, etc. The health promotion data 102 are communicated to the patch having an associated with the methodology module 104. The methodology module 104 may process the health promotion data 102 to identify the corresponding swimmer patch methodology. The instruction module 106 may initiate an instruction whereby program(s) associated with the patch generate vibratory or other messages, e.g., blinking lights, data display, etc., on the recipient's detector.

Small Steps to Big Results Methodology

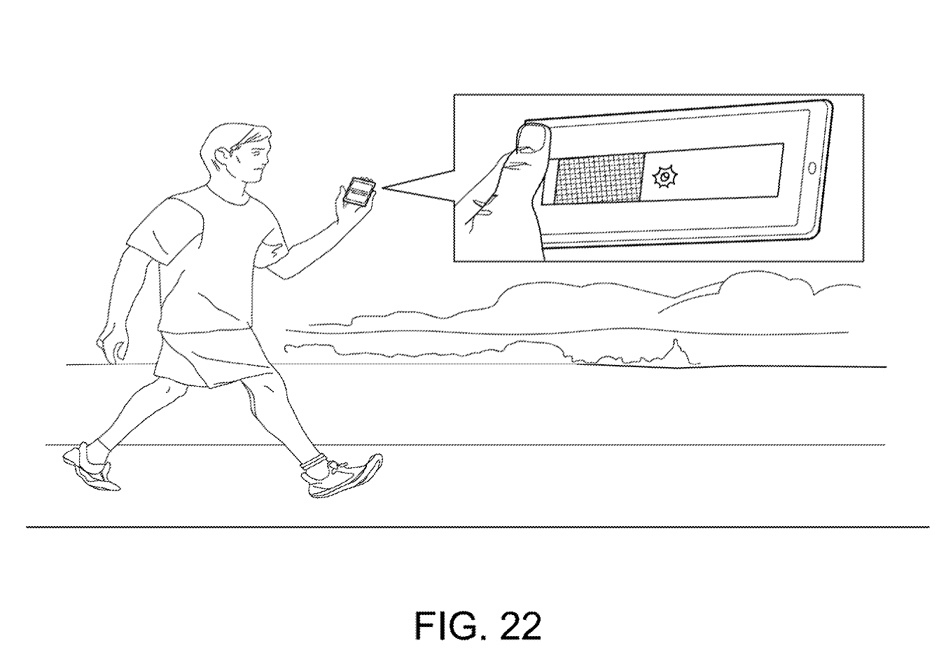

The small steps to big results methodology, as conceptually illustrated in FIG. 22, encourages physical activity by setting the goal of merely surpassing one's previous scores. By tracking information on physical activity, the system visually shows users their prior performance and guides them to beat it by exercising to move the representational dot past the threshold line. Any user who lapses is guided back through manageable and encouragingly gradual goal-setting. It transforms imposing long-term goals into smaller, more achievable goals.

Examples of implementation include generation of the health promotion data 102, e.g., physical activity data, etc. The health promotion data 102 are communicated to a hub, e.g., the user's mobile phone, associated with the methodology module 104. The methodology module 104 may process the health promotion data 102 to identify the corresponding small steps to big results methodology. The instruction module 106 may initiate an instruction whereby program(s) associated with the system retrieve stored data of prior performances, compare it to the current health promotion data 102, and display the results via encouraging visual displays, etc.

Commit to Healthy Eating Methodology

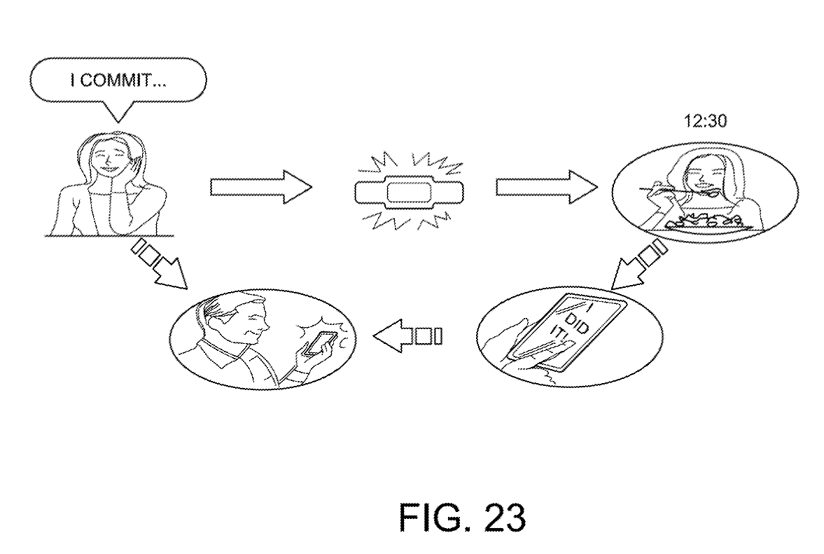

The commit to healthy eating methodology, as illustrated in FIG. 23, provides a system that encourages healthy eating habits through commitment pills and reminders. At the start of the day, the user takes pills, e.g., placebos, vitamins, etc., having associated ingestible devices, that represent their commitment to eating a certain number of vegetable or fruit servings and this commitment is noted on social media, e.g., her Facebook™ page. As each mealtime arrives, her patch vibrates to remind her of her commitment and upon acknowledging that she has eaten properly, the achievement is posted (celebrated) on her Facebook™ wall. By presenting commitments publicly, users feel more obligated to complete them. Additionally, planning healthy eating behaviors at the start of each day enables users to become more mindful about diet.

Similarly, a “placebo pills” methodology provides a system of “intention pills” e.g., placebos, vitamins, etc. that serve as an indicator or reminder of a user's intent, commitment, etc. The intention pill may be ingested as an individual program, as part of group participation, an empathy relay, a treatment simulation pill, etc. To illustrate, a user may commit to ingesting, and ingest, a placebo each time a friend has to ingest a prescribed medication for a treatment regimen. The commitment to “co-ingest” and the act of solidarity both show a real and/or continual support of the friend's plight and progress as well as helps the user offer to the friend.

The intention pill may trigger a thing to change for the user, make intentions of the user tangible to them and others, make the user feel empowered, enable the user to reach their goal, etc. Group participation may permit the user to feel as if the user is part of a bigger cause, e.g., group invitation, reinforce the user's reason(s) for participating, and help the user connect to like-minded people. The empathy relay may provide a support for the user's friend, give the user something to do for a friend, show the user's support, offer a continual support for the friend, etc. The treatment simulation pill may assist the user in avoiding a behavior, choices, etc., that worsen the user's condition, assist the user in experiencing the ramification of a treatment regimen in the user's life, give the user a reason to change his/her behavior to avoid potential consequences associated with foregoing a behavior change, etc. The placebo pills methodology may enhance behavior changes, etc., for persons

Examples of implementation include generation of the health promotion data 102, e.g., ingestion event data. The health promotion data 102 are communicated to a website associated with the methodology module 104. The methodology module 104 may process the health promotion data 102 to identify the corresponding commit to healthy eating methodology. The instruction module 106 may initiate an instruction whereby program(s) and associated system(s) generate a comment on Facebook™ relevant to the commitment, generates timely and meaningful reminders, and, upon predetermined conditions, post celebratory comments on Facebook™ regarding the accomplishment.

Matched Methodology

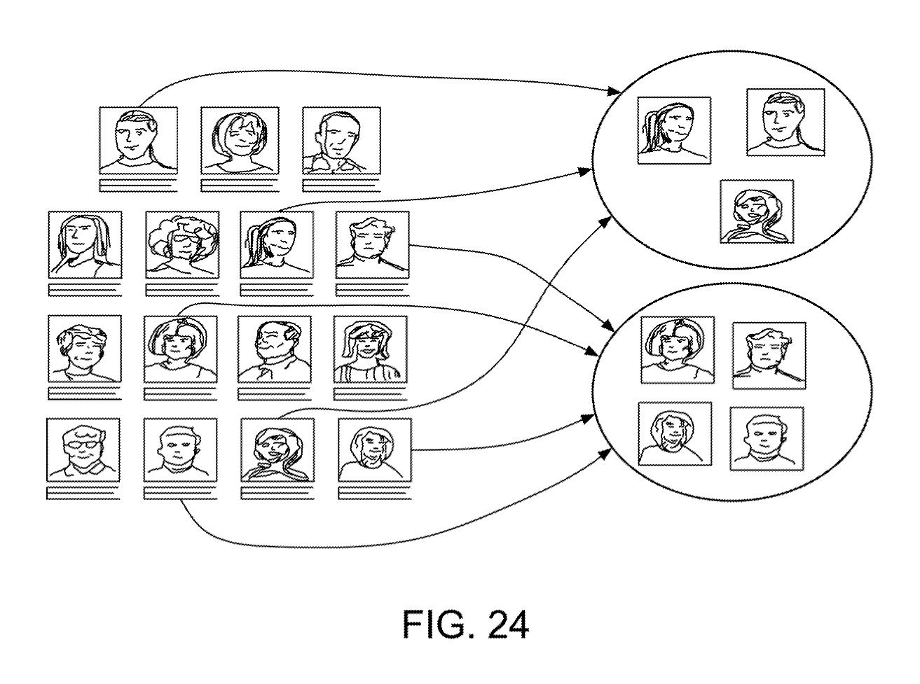

The matched methodology, as conceptually illustrated in FIG. 24, provides a system that selects people to form optimal support groups based on ailments, goals, needs, etc. Using information on user's adherence to medication and fitness regimens as well as collected personality data, this system groups people with similar (or potentially complementary) support needs to form inspirational and relatable groups for maximum benefit. Offering users a meaningfully matched support group both increases the potential for the group to be effective, and possibly alleviates fears of joining a group with an unknown composition.

Examples of implementation include generation of the health promotion data 102, e.g., user adherence data, etc. The health promotion data 102 are communicated to a website associated with the methodology module 104. The methodology module 104 may process the health promotion data 102 to identify the corresponding matched methodology. The instruction module 106 may initiate an instruction whereby program(s) and associated system(s) match the user to group(s) of persons based on predetermined criteria, e.g., disease condition, fitness regimen, medication regimen, etc. and facilitate an online networking forum between support group members.

### Method

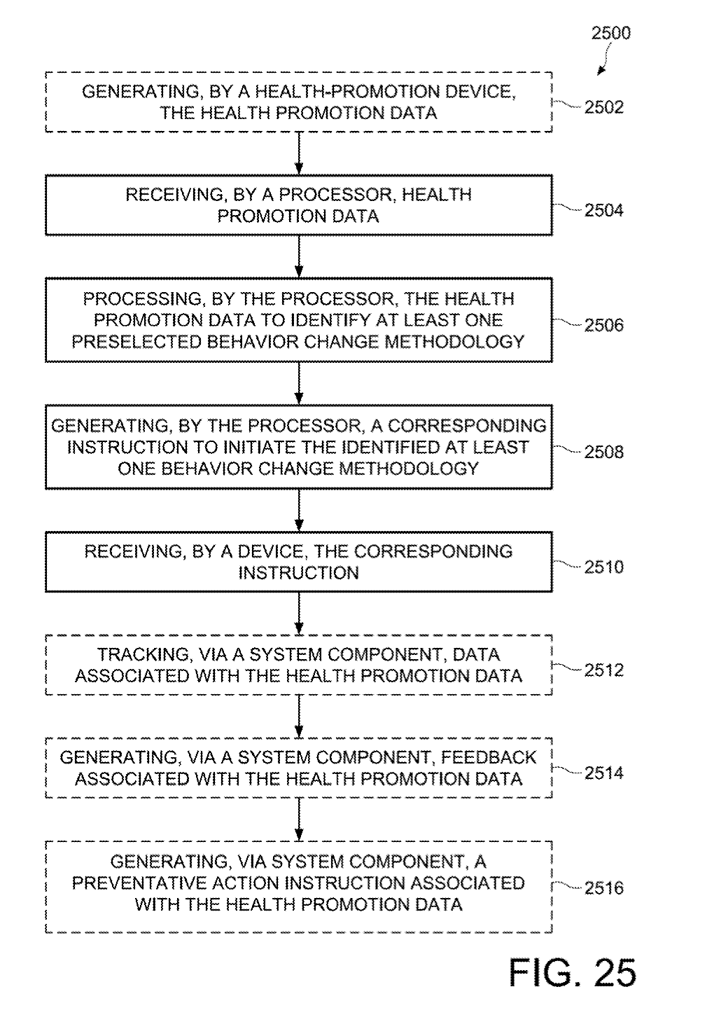

With reference now to FIG. 25, there is shown a method to prompt behavior change 2500. In various aspects, the method may optionally (illustrated in phantom outline) consist of an initial step of generating, by a health-promotion device, the health promotion data at step 2502. In various aspects, the method may consist/comprise steps of: receiving, by a processor, health promotion data at step 2504; processing, by the processor, the health promotion data to identify at least one preselected behavior change methodology at step 2506; and generating, by the processor, a corresponding instruction to initiate the identified at least one behavior change methodology at step 2508. In various aspects, the method may optionally consist or comprise of one or more of the following steps: receiving, by a device, the corresponding instruction at step 2510; tracking, via a system component, data associated with the health promotion data at step 2512; generating feedback, via a system component, associated with the health promotion data at step 2514; and generating, via a system component, a preventative action instruction associated with the health promotion data at step 2516.

In various aspects, and as heretofore discussed, the health promotion data may be associated with various health-related events and combinations thereof, e.g., an ingestion event, an injection event, an inhalation event, an infusion event, a health monitoring event, an physical activity event, and an eating event. To illustrate, the health promotion data related to an ingestion event may be generated by an ingestible device such as an RFID-enabled device, a current-altering device, etc.

The behavior change methodologies include various examples of methodologies which function to prompt behavior, e.g., a desirable, sustainable behavior change associated with a health-related issue, event, regimen, etc.; to engender empathy, e.g., identify with a cause, garner family support, etc., which may prompt a behavior change, etc. The non-exhaustive list of examples previously discussed may be applied in various aspects of the method, e.g., a medmatch methodology; a races within reach methodology; a pick a desktop widget/avatar methodology; a family responsibility methodology; a virtual mansion methodology; a daily hatch methodology; a fitimals methodology; a delightful comparators methodology; an adhere to win methodology; a shame game methodology; a pledge matching methodology; a help from my friends methodology; a love buzz methodology; a patch alerts methodology; a done!buzz methodology; a plug methodology; a real patient profiles methodology; a mood miner methodology; a heart fit methodology; a swimmer patch methodology; a small steps to big results methodology; a commit to healthy eating methodology; and a matched methodology. Preselection may be various modes, e.g., manual selection by a participant, automated selection, a combination thereof, etc.

The medmatch methodology, for example, may incorporate or otherwise be associated with direct or indirect support of an individual or cause in need, an economic consequence, etc. In this example, the donor using the medmatch methodology may empathize to the individual or cause in need to be motivated to make and maintain a behavior change having a positive impact on a health-related outcome for the donor. Similarly, the donor may identify with enabling or avoiding an economic consequence to the donor, a donation recipient, or other(s) to a degree that motivates such a behavior change.

The medmatch methodology may include, but does not necessarily, a verifiable donation transaction, e.g., computer-generated feedback to the donor and other interested parties; a quantifiable donation, e.g., two pills donated for every pill ingested by the donor, etc.

### Article

In various aspects, an article may comprise a non-transitory storage medium having instructions, that when executed by a computing platform, result in execution of a method of communicating health promotion data via a network, comprising/consisting of: receiving, via a hub, the health promotion data; communicating, via the hub, at least a portion of the health promotion data to a methodology module; identifying, via a methodology module, at least one methodology associated with the health promotion data; and generating, via an instruction module, at least one instruction associated with the identified methodology.

The article may further consist/comprise one or more of the following steps of: tracking, via a component of the network, data associated with the health promotion data; generating, via a component of the network, data associated with the health promotion data; and generating, via a component of the network, a preventative action instruction associated with the health promotion data.

Any of the aspects disclosed herein may be performed in a data processing system or by a data processing method, e.g., instructional steps carried out by a computer, processor, etc. To illustrate, a diagrammatic system comprises, for example, a processor, a main memory, a static memory, a bus, a video display, an alpha-numeric input device, a cursor control device, a drive unit, a signal generation device, a network interface device, a machine readable medium, instructions and a network, according to one embodiment.

The diagrammatic system may indicate a personal computer and/or a data processing system in which one or more operations disclosed herein may be performed. The processor may be a microprocessor, a state machine, an application-specific integrated circuit, a field programmable gate array, etc. The main memory may be a dynamic random access memory and/or a primary memory of a computer system. The static memory may be a hard drive, a flash drive, and/or other memory information associated with the data processing system.

The bus may be an interconnection between various circuits and/or structures of the data processing system. The video display may provide graphical representation of information on the data processing system. The alpha-numeric input device may be a keypad, a keyboard and/or any other input device of text, e.g., a special device to aid the physically challenged. The cursor control device may be a pointing device such as a mouse. The drive unit may be a hard drive, a storage system, and/or other longer term storage subsystem. The signal generation device may be a bios and/or a functional operating system of the data processing system. The network interface device may be a device that may perform interface functions such as code conversion, protocol conversion and/or buffering required for communication to and from the network. The machine readable medium may provide instructions on which any of the methods disclosed herein may be performed. The instructions may provide source code and/or data code to the processor to enable any one/or more operations disclosed herein.

Although the present embodiments have been described with reference to specific example embodiments, it will be evident that various modifications and changes may be made to these embodiments without departing from the broader spirit and scope of the various embodiments. For example, the various devices, modules, etc. described herein may be enabled and operated using hardware circuitry, e.g., CMOS based logic circuitry, firmware, software and/or any combination of hardware, firmware, and/or software, e.g., embodied in a machine readable medium.

For example, the various electrical structure and methods may be embodied using transistors, logic gates, and electrical circuits, e.g., Application Specific Integrated circuitry (ASIC) and/or in Digital Signal Processor (DSP) circuitry. For example, the receive module and the communicate module and other modules may be enabled using one or more of the technologies described herein.

In addition, it will be appreciated that the various operations, processes, and methods disclosed herein may be embodied in a machine-readable medium and/or a machine accessible medium compatible with a data processing system, e.g., a computer system, and may be performed in any order. Accordingly, the specification and drawings are to be regarded in an illustrative rather than a restrictive sense.

Any or all data associated with the aforementioned devices and methods, for example, may be used alone or in combination with other data to constitute health promotion data, e.g., data having a health promotion aspect.

In certain embodiments, the system and/or method steps further includes/utilizes an element for storing data, e.g., a data storage element, where this element is present on an external device, such as a bedside monitor, PDA, smart phone, computer server, etc. Typically, the data storage element is a computer readable medium. The term “computer readable medium” as used herein refers to any storage or transmission medium that participates in providing instructions and/or data to a computer for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external to the computer. A file containing information may be “stored” on a computer readable medium, where “storing” means recording information such that it is accessible and retrievable at a later data by a computer and/or computer-related component. With respect to computer readable media, “permanent memory” refers to memory that is permanent. Permanent memory is not erased by termination of the electrical supply to a computer of processor. Computer hard-drive ROM, e.g., not used as virtual memory, CD-ROM, floppy disk and DVD are all examples of permanent memory. Random Access Memory (RAM) is an example of non-permanent memory. A file in permanent memory may be editable and re-writable.

Aspects extend to any manner of reading and monitoring the sensed parameters of medication and non-medication taking, administration and/or delivery, e.g., an adhesive sensor patch, other wearable sensors, device implants and insertables, parenteral medication delivery devices, mobile phones, etc., and devices to display and manage such information (computers, mobile phones, etc).

Further, various aspects may include one or more data fusion functions. As used herein, the term “data fusion” refers to a process, function, occurrence, event, etc. of data integration, e.g., combining of data, coupled with a reduction, replacement, analysis or other such data manipulation or change that brings about an improved result with respect to the combined data. Examples of improved results include combination of health promotion data and data resulting from one or more of the previously described methodologies from which, when analyzed, a reasonable inference may be drawn that an individual associated with the health promotion data has changed behavior patterns, resulting in improved adherence to a medication regimen and an improved treatment outcome.

Also provided are computer executable instructions, e.g., programming, for performing the above methods, e.g., for programming the IEM, receiver, and other components of the system. The computer executable instructions are present on a computer readable medium. Accordingly, various aspects provide a computer readable medium containing programming for use in providing ingestible event marker data.

As such, in certain embodiments the systems include one or more of: a data storage element, a data processing element, a data display element, a data transmission element, a notification mechanism, and a user interface. These elements may be present or otherwise associated with at least one of the ingestible event marker data, the hub, and the IEM data systems.

One of the above-described systems is reviewed in terms of a receive module and a communicate module. The aspects, however, are not so limited. In a broader sense, the systems are composed of two or more different modules that communicate with each other, e.g., using the hub functionalities as reviewed above, e.g., using the IEM data in the communication, e.g., using the IEM data systems' functionalities.

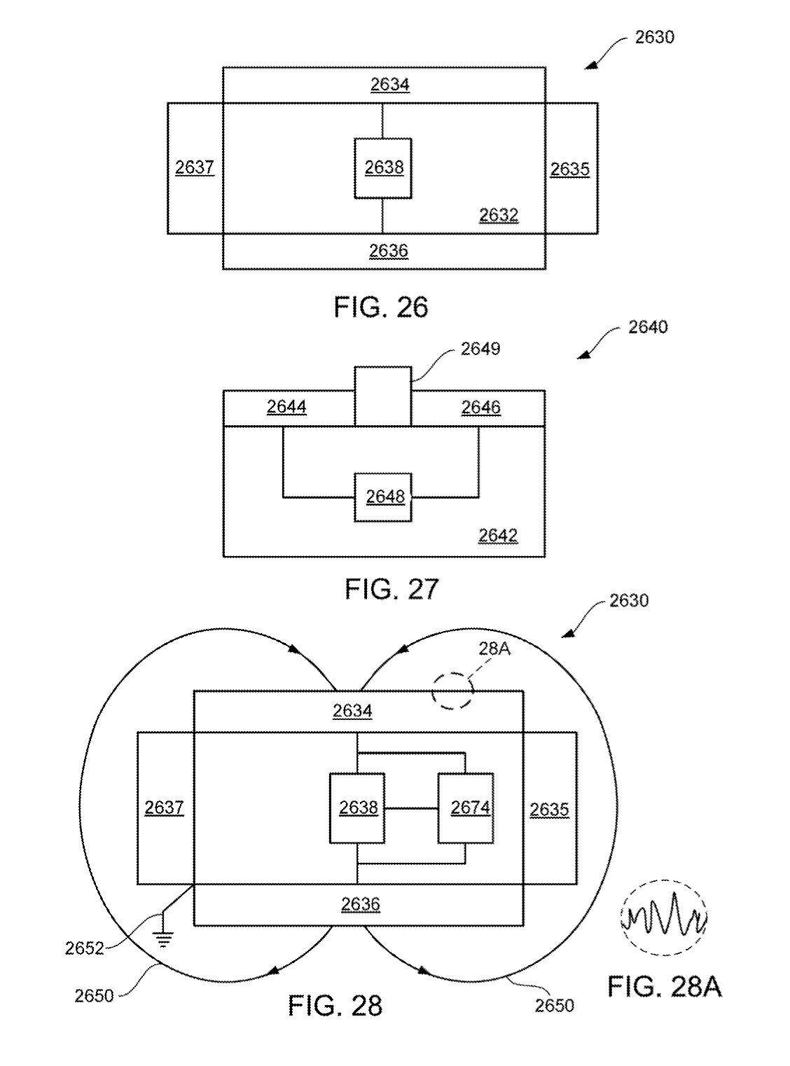

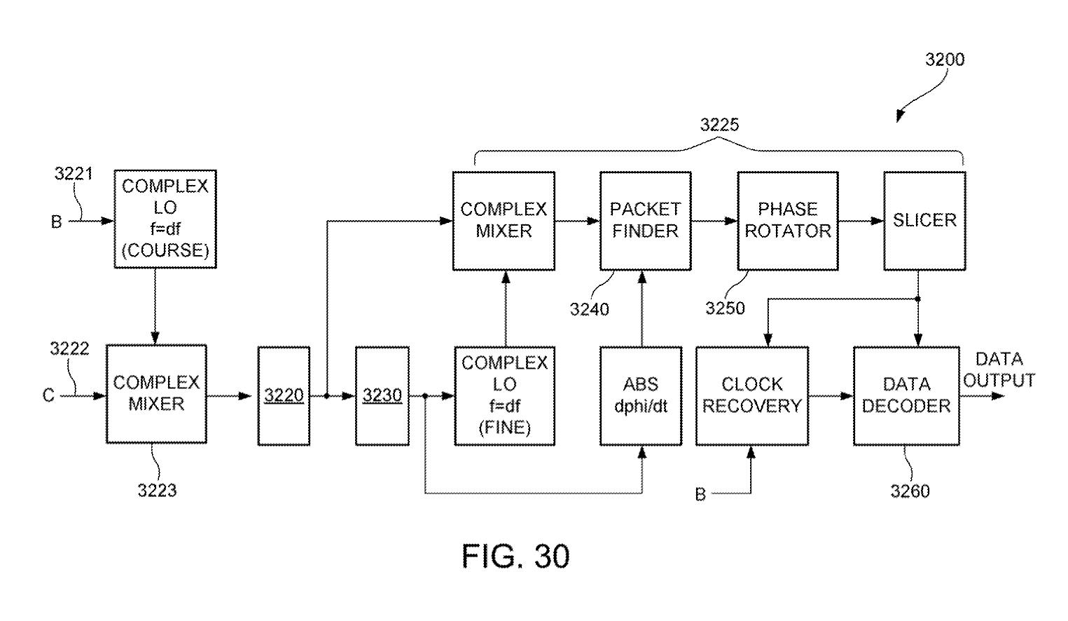

Various enabling aspects of the IEM are illustrated in FIGS. 26-29 below. It is appreciated that the IEM may be a system which comprises a partial power source that can be activated when in contact with conductive liquid and is capable of controlling conductance to mark an event. In the instance where the system is used with the product that is ingested by the living organism, when the product that includes the system is taken or ingested, the device comes into contact with the conducting liquid of the body. When the system of the present disclosure comes into contact with the body fluid, a voltage potential is created and the system is activated. A portion of the power source is provided by the device, while another portion of the power source is provided by the conducting fluid. That is, once ingested, the system comes into contact with body liquids and the system is activated. The system uses the voltage potential difference to power up and thereafter modulates conductance to create a unique and identifiable current signature. Upon activation, the system controls the conductance and, hence, current flow to produce the current signature. In addition, various enabling aspects of the receiver/detector are illustrated in FIGS. 30-35 below.

With reference to FIG. 26, there is shown one aspect of an ingestible device event indicator system with dissimilar metals positioned on opposite ends as system 2630. The system 2630 can be used in association with any pharmaceutical product, as mentioned above, to determine when a patient takes the pharmaceutical product. As indicated above, the scope of the present disclosure is not limited by the environment and the product that is used with the system 2630. For example, the system 2630 may be placed within a capsule and the capsule is placed within the conducting liquid. The capsule would then dissolve over a period of time and release the system 2630 into the conducting liquid. Thus, in one aspect, the capsule would contain the system 2630 and no product. Such a capsule may then be used in any environment where a conducting liquid is present and with any product. For example, the capsule may be dropped into a container filled with jet fuel, salt water, tomato sauce, motor oil, or any similar product. Additionally, the capsule containing the system 2630 may be ingested at the same time that any pharmaceutical product is ingested in order to record the occurrence of the event, such as when the product was taken.

In the specific example of the system 2630 combined with the pharmaceutical product, as the product or pill is ingested, the system 2630 is activated. The system 2630 controls conductance to produce a unique current signature that is detected, thereby signifying that the pharmaceutical product has been taken. The system 2630 includes a framework 2632. The framework 2632 is a chassis for the system 2630 and multiple components are attached to, deposited upon, or secured to the framework 2632. In this aspect of the system 2630, a digestible material 2634 is physically associated with the framework 2632. The material 2634 may be chemically deposited on, evaporated onto, secured to, or built-up on the framework all of which may be referred to herein as “deposit” with respect to the framework 2632. The material 2634 is deposited on one side of the framework 2632. The materials of interest that can be used as material 2634 include, but are not limited to: Cu or CuI. The material 2634 is deposited by physical vapor deposition, electrodeposition, or plasma deposition, among other protocols. The material 2634 may be from about 0.05 to about 500 .mu.m thick, such as from about 5 to about 100 .mu.m thick. The shape is controlled by shadow mask deposition, or photolithography and etching. Additionally, even though only one region is shown for depositing the material, each system 2630 may contain two or more electrically unique regions where the material 2634 may be deposited, as desired.

At a different side, which is the opposite side as shown in FIG. 26, another digestible material 2636 is deposited, such that materials 2634 and 2636 are dissimilar. Although not shown, the different side selected may be the side next to the side selected for the material 2634. The scope of the present disclosure is not limited by the side selected and the term “different side” can mean any of the multiple sides that are different from the first selected side. Furthermore, even though the shape of the system is shown as a square, the shape maybe any geometrically suitable shape. Material 2634 and 2636 are selected such that they produce a voltage potential difference when the system 2630 is in contact with conducting liquid, such as body fluids. The materials of interest for material 2636 include, but are not limited to: Mg, Zn, or other electronegative metals. As indicated above with respect to the material 2634, the material 2636 may be chemically deposited on, evaporated onto, secured to, or built-up on the framework. Also, an adhesion layer may be necessary to help the material 2636 (as well as material 2634 when needed) to adhere to the framework 2632. Typical adhesion layers for the material 2636 are Ti, TiW, Cr or similar material. Anode material and the adhesion layer may be deposited by physical vapor deposition, electrodeposition or plasma deposition. The material 2636 may be from about 0.05 to about 500 .mu.m thick, such as from about 5 to about 100 .mu.m thick. However, the scope of the present disclosure is not limited by the thickness of any of the materials nor by the type of process used to deposit or secure the materials to the framework 2632.

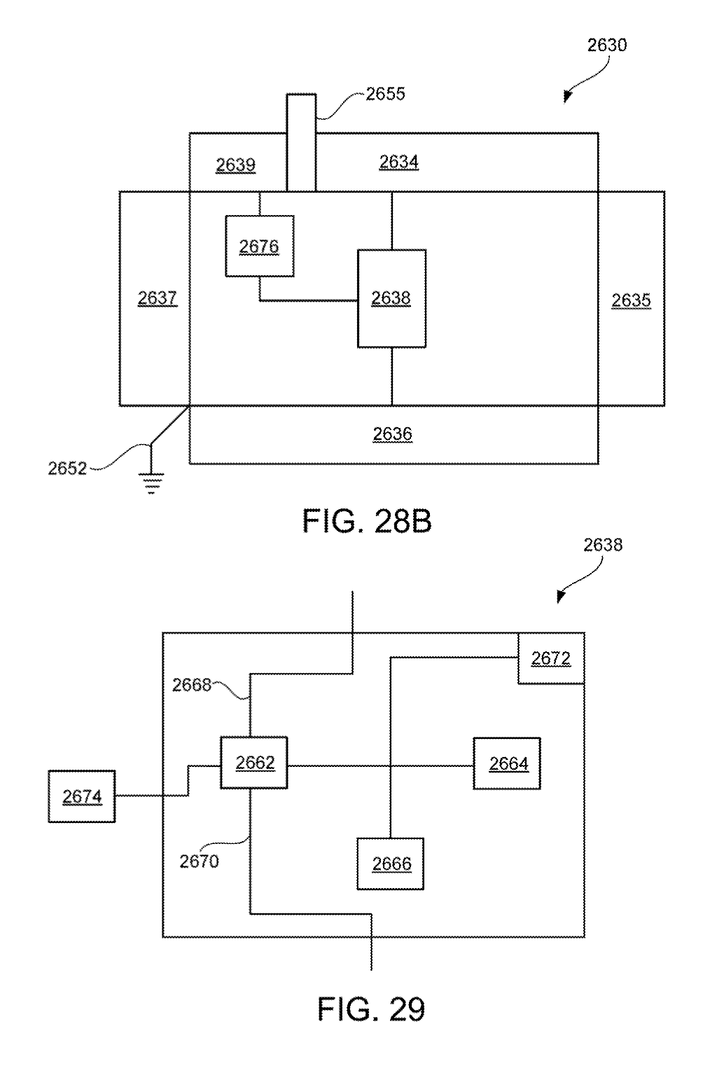

Thus, when the system 2630 is in contact with the conducting liquid, a current path, an example is shown in FIG. 28, is formed through the conducting liquid between material 2634 and 2636. A control device 2638 is secured to the framework 2632 and electrically coupled to the materials 2634 and 2636. The control device 2638 includes electronic circuitry, for example control logic that is capable of controlling and altering the conductance between the materials 2634 and 2636.

The voltage potential created between the materials 2634 and 2636 provides the power for operating the system as well as produces the current flow through the conducting fluid and the system. In one aspect, the system operates in direct current mode. In an alternative aspect, the system controls the direction of the current so that the direction of current is reversed in a cyclic manner, similar to alternating current. As the system reaches the conducting fluid or the electrolyte, where the fluid or electrolyte component is provided by a physiological fluid, e.g., stomach acid, the path for current flow between the materials 2634 and 2636 is completed external to the system 2630; the current path through the system 2630 is controlled by the control device 2638. Completion of the current path allows for the current to flow and in turn a receiver can detect the presence of the current and recognize that the system 2630 has been activated and the desired event is occurring or has occurred.

In one aspect, the two materials 2634 and 2636 are similar in function to the two electrodes needed for a direct current power source, such as a battery. The conducting liquid acts as the electrolyte needed to complete the power source. The completed power source described is defined by the physical chemical reaction between the materials 2634 and 2636 of the system 2630 and the surrounding fluids of the body. The completed power source may be viewed as a power source that exploits reverse electrolysis in an ionic or a conductive solution such as gastric fluid, blood, or other bodily fluids and some tissues. Additionally, the environment may be something other than a body and the liquid may be any conducting liquid. For example, the conducting fluid may be salt water or a metallic based paint.

In certain aspects, these two materials are shielded from the surrounding environment by an additional layer of material. Accordingly, when the shield is dissolved and the two dissimilar materials are exposed to the target site, a voltage potential is generated.

Referring again to FIG. 26, the materials 2634 and 2636 provide the voltage potential to activate the control device 2638. Once the control device 2638 is activated or powered up, the control device 2638 can alter conductance between the materials 2634 and 2636 in a unique manner. By altering the conductance between materials 2634 and 2636, the control device 2638 is capable of controlling the magnitude of the current through the conducting liquid that surrounds the system 2630. This produces a unique current signature that can be detected and measured by a receiver, which can be positioned internal or external to the body. In addition to controlling the magnitude of the current path between the materials, non-conducting materials, membrane, or “skirt” are used to increase the “length” of the current path and, hence, act to boost the conductance path, as disclosed in the U.S. patent application Ser. No. 12/238,345 filed Sep. 25, 2608, published 2609-0082645, and entitled, “In-Body Device with Virtual Dipole Signal Amplification”, the entire content of which is incorporated herein by reference. Alternatively, throughout the disclosure herein, the terms “non-conducting material,” “membrane,” and “skirt” are interchangeably with the term “current path extender” without impacting the scope or the present aspects and the claims herein. The skirt, shown in portion at 2635 and 2637, respectively, may be associated with, e.g., secured to, the framework 2632. Various shapes and configurations for the skirt are contemplated as within the scope of the present disclosure. For example, the system 2630 may be surrounded entirely or partially by the skirt and the skirt maybe positioned along a central axis of the system 2630 or off-center relative to a central axis. Thus, the scope of the present disclosure as claimed herein is not limited by the shape or size of the skirt. Furthermore, in other aspects, the materials 2634 and 2636 may be separated by one skirt that is positioned in any defined region between the materials 2634 and 2636.

Referring now to FIG. 27, in another aspect of an ingestible device is shown in more detail as system 2640. The system 2640 includes a framework 2642. The framework 2642 is similar to the framework 2632 of FIG. 26. In this aspect of the system 2640, a digestible or dissolvable material 2644 is deposited on a portion of one side of the framework 2642. At a different portion of the same side of the framework 2642, another digestible material 2646 is deposited, such that materials 2644 and 2646 are dissimilar. More specifically, material 2644 and 2646 are selected such that they form a voltage potential difference when in contact with a conducting liquid, such as body fluids. Thus, when the system 2640 is in contact with and/or partially in contact with the conducting liquid, then a current path, an example is shown in FIG. 28, is formed through the conducting liquid between material 2644 and 2646. A control device 2648 is secured to the framework 2642 and electrically coupled to the materials 2644 and 2646. The control device 2648 includes electronic circuitry that is capable of controlling part of the conductance path between the materials 2644 and 2646. The materials 2644 and 2646 are separated by a non-conducting skirt 2649. Various examples of the skirt 2649 are disclosed in U.S. Provisional Application No. 61/173,511 filed on Apr. 28, 2609 and entitled “HIGHLY RELIABLE INGESTIBLE EVENT MARKERS AND METHODS OF USING SAME” and U.S. Provisional Application No. 61/173,564 filed on Apr. 28, 2609 and entitled “INGESTIBLE EVENT MARKERS HAVING SIGNAL AMPLIFIERS THAT COMPRISE AN ACTIVE AGENT”; as well as U.S. application Ser. No. 12/238,345 filed Sep. 25, 2608, published 2609-0082645, entitled “IN-BODY DEVICE WITH VIRTUAL DIPOLE SIGNAL AMPLIFICATION”; the entire disclosure of each is incorporated herein by reference.

Once the control device 2648 is activated or powered up, the control device 2648 can alter conductance between the materials 2644 and 2646. Thus, the control device 2648 is capable of controlling the magnitude of the current through the conducting liquid that surrounds the system 2640. As indicated above with respect to system 2630, a unique current signature that is associated with the system 2640 can be detected by a receiver to mark the activation of the system 2640. In order to increase the “length” of the current path the size of the skirt 2649 is altered. The longer the current path, the easier it may be for the receiver to detect the current.

Referring now to FIG. 28, the system 2630 of FIG. 26 is shown in an activated state and in contact with conducting liquid. The system 2630 is grounded through ground contact 2652. The system 2630 also includes a sensor module 2674, which is described in greater detail with respect to FIG. 27. Ion or current paths 2650 form between material 2634 to material 2636 through the conducting fluid in contact with the system 2630. The voltage potential created between the material 2634 and 2636 is created through chemical reactions between materials 2634/2636 and the conducting fluid.

FIG. 28A shows an exploded view of the surface of the material 2634. The surface of the material 2634 is not planar, but rather an irregular surface 2654 as shown. The irregular surface 2654 increases the surface area of the material and, hence, the area that comes in contact with the conducting fluid.

In one aspect, at the surface of the material 2634, there is chemical reaction between the material 2634 and the surrounding conducting fluid such that mass is released into the conducting fluid. The term “mass” as used herein refers to protons and neutrons that form a substance. One example includes the instant where the material is CuCI and when in contact with the conducting fluid, CuCI becomes Cu (solid) and CI.sup.- in solution. The flow of ions into the conduction fluid is depicted by the ion paths 2650. In a similar manner, there is a chemical reaction between the material 2636 and the surrounding conducting fluid and ions are captured by the material 2636. The release of ions at the material 2634 and capture of ion by the material 2636 is collectively referred to as the ionic exchange. The rate of ionic exchange and, hence the ionic emission rate or flow, is controlled by the control device 2638. The control device 2638 can increase or decrease the rate of ion flow by altering the conductance, which alters the impedance, between the materials 2634 and 2636. Through controlling the ion exchange, the system 2630 can encode information in the ionic exchange process. Thus, the system 2630 uses ionic emission to encode information in the ionic exchange.

The control device 2638 can vary the duration of a fixed ionic exchange rate or current flow magnitude while keeping the rate or magnitude near constant, similar to when the frequency is modulated and the amplitude is constant. Also, the control device 2638 can vary the level of the ionic exchange rate or the magnitude of the current flow while keeping the duration near constant. Thus, using various combinations of changes in duration and altering the rate or magnitude, the control device 2638 encodes information in the current flow or the ionic exchange. For example, the control device 2638 may use, but is not limited to any of the following techniques namely, Binary Phase-Shift Keying (PSK), Frequency modulation, Amplitude modulation, on-off keying, and PSK with on-off keying.

As indicated above, the various aspects disclosed herein, such as systems 2630 and 2640 of FIGS. 26 and 27, respectively, include electronic components as part of the control device 2638 or the control device 2648. Components that may be present include but are not limited to: logic and/or memory elements, an integrated circuit, an inductor, a resistor, and sensors for measuring various parameters. Each component may be secured to the framework and/or to another component. The components on the surface of the support may be laid out in any convenient configuration. Where two or more components are present on the surface of the solid support, interconnects may be provided.

As indicated above, the system, such as system 2630 and 2640, control the conductance between the dissimilar materials and, hence, the rate of ionic exchange or the current flow. Through altering the conductance in a specific manner the system is capable of encoding information in the ionic exchange and the current signature. The ionic exchange or the current signature is used to uniquely identify the specific system. Additionally, the systems 2630 and 2640 are capable of producing various different unique exchanges or signatures and, thus, provide additional information. For example, a second current signature based on a second conductance alteration pattern may be used to provide additional information, which information may be related to the physical environment. To further illustrate, a first current signature may be a very low current state that maintains an oscillator on the chip and a second current signature may be a current state at least a factor of ten higher than the current state associated with the first current signature.

Referring now to FIG. 29, a block diagram representation of the control device 2638 is shown. The device 2638 includes a control module 2662, a counter or clock 2664, and a memory 2666. Additionally, the device 2638 is shown to include a sensor module 2672 as well as the sensor module 2674, which was referenced in FIG. 28. The control module 2662 has an input 2668 electrically coupled to the material 2634 and an output 2670 electrically coupled to the material 2636. The control module 2662, the clock 2664, the memory 2666, and the sensor modules 2672/2674 also have power inputs (some not shown). The power for each of these components is supplied by the voltage potential produced by the chemical reaction between materials 2634 and 2636 and the conducting fluid, when the system 2630 is in contact with the conducting fluid.

The control module 2662 controls the conductance through logic that alters the overall impedance of the system 2630. The control module 2662 is electrically coupled to the clock 2664. The clock 2664 provides a clock cycle to the control module 2662. Based upon the programmed characteristics of the control module 2662, when a set number of clock cycles have passed, the control module 2662 alters the conductance characteristics between materials 2634 and 2636. This cycle is repeated and thereby the control device 2638 produces a unique current signature characteristic. The control module 2662 is also electrically coupled to the memory 2666. Both the clock 2664 and the memory 2666 are powered by the voltage potential created between the materials 2634 and 2636.

The control module 2662 is also electrically coupled to and in communication with the sensor modules 2672 and 2674. In the aspect shown, the sensor module 2672 is part of the control device 2638 and the sensor module 2674 is a separate component. In alternative aspects, either one of the sensor modules 2672 or 2674 can be used without the other, and the scope of the present disclosure is not limited by the structural or functional location of the sensor modules 2672 or 2674. Additionally, any component of the system 2630 may be functionally or structurally moved, combined, or repositioned without limiting the scope of the present disclosure as claimed. Thus, it is possible to have one single structure, for example a processor, which is designed to perform the functions of all of the following modules: the control module 2662, the clock 2664, the memory 2666, and the sensor module 2672 or 2674. On the other hand, it is also within the scope of the present disclosure to have each of these functional components located in independent structures that are linked electrically and able to communicate.

Referring again to FIG. 29, the sensor modules 2672 or 2674 can include any of the following sensors: temperature, pressure, pH level, and conductivity. In one aspect, the sensor modules 2672 or 2674 gather information from the environment and communicate the analog information to the control module 2662. The control module then converts the analog information to digital information and the digital information is encoded in the current flow or the rate of the transfer of mass that produces the ionic flow. In another aspect, the sensor modules 2672 or 2674 gather information from the environment and convert the analog information to digital information and then communicate the digital information to control module 2662. In the aspect shown in FIG. 28, the sensor modules 2674 is shown as being electrically coupled to the material 2634 and 2636 as well as the control device 2638. In another aspect, as shown in FIG. 29, the sensor module 2674 is electrically coupled to the control device 2638 at a connection. The connection acts as both a source for power supply to the sensor module 2674 and a communication channel between the sensor module 2674 and the control device 2638.

Referring now to FIG. 28B, the system 2630 includes a pH sensor module 2676 connected to a material 2639, which is selected in accordance with the specific type of sensing function being performed. The pH sensor module 2676 is also connected to the control device 2638. The material 2639 is electrically isolated from the material 2634 by a non-conductive barrier 2655. In one aspect, the material 2639 is platinum. In operation, the pH sensor module 2676 uses the voltage potential difference between the materials 2634/2636. The pH sensor module 2676 measures the voltage potential difference between the material 2634 and the material 2639 and records that value for later comparison. The pH sensor module 2676 also measures the voltage potential difference between the material 2639 and the material 2636 and records that value for later comparison. The pH sensor module 2676 calculates the pH level of the surrounding environment using the voltage potential values. The pH sensor module 2676 provides that information to the control device 2638. The control device 2638 varies the rate of the transfer of mass that produces the ionic transfer and the current flow to encode the information relevant to the pH level in the ionic transfer, which can be detected by a receiver. Thus, the system 2630 can determine and provide the information related to the pH level to a source external to the environment.

As indicated above, the control device 2638 can be programmed in advance to output a pre-defined current signature. In another aspect, the system can include a receiver system that can receive programming information when the system is activated. In another aspect, not shown, the switch 2664 and the memory 2666 can be combined into one device.

In addition to the above components, the system 2630 may also include one or other electronic components. Electrical components of interest include, but are not limited to: additional logic and/or memory elements, e.g., in the form of an integrated circuit; a power regulation device, e.g., battery, fuel cell or capacitor; a sensor, a stimulator, etc.; a signal transmission element, e.g., in the form of an antenna, electrode, coil, etc.; a passive element, e.g., an inductor, resistor, etc.

FIG. 30 provides a functional block diagram of how a receiver may implement a coherent demodulation protocol, according to one aspect of the disclosure. It should be noted that only a portion of the receiver is shown in FIG. 30. FIG. 30 illustrates the process of mixing the signal down to baseband once the carrier frequency (and carrier signal mixed down to carrier offset) is determined. A carrier signal 3221 is mixed with a second carrier signal 3222 at mixer 3223. A narrow low-pass filter 3220 is applied of appropriate bandwidth to reduce the effect of out-of-bound noise. Demodulation occurs at functional blocks 3225 in accordance with the coherent demodulation scheme of the present disclosure. The unwrapped phase 3230 of the complex signal is determined. An optional third mixer stage, in which the phase evolution is used to estimate the frequency differential between the calculated and real carrier frequency can be applied. The structure of the packet is then leveraged to determine the beginning of the coding region of the BPSK signal at block 3240. Mainly, the presence of the sync header, which appears as an FM porch in the amplitude signal of the complex demodulated signal is used to determine the starting bounds of the packet. Once the starting point of the packet is determined the signal is rotated at block 3250 on the IQ plane and standard bit identification and eventually decoded at block 3260.

In addition to demodulation, the transbody communication module may include a forward error correction module, which module provides additional gain to combat interference from other unwanted signals and noise. Forward error correction functional modules of interest include those described in PCT Application Serial No. PCT/US2007/024325 published as WO/2008/063626; the disclosure of which is herein incorporated by reference. In some instances, the forward error correction module may employ any convenient protocol, such as Reed-Solomon, Golay, Hamming, BCH, and Turbo protocols to identify and correct (within bounds) decoding errors.

Receivers of the disclosure may further employ a beacon functionality module. In various aspects, the beacon switching module may employ one or more of the following: a beacon wakeup module, a beacon signal module, a wave/frequency module, a multiple frequency module, and a modulated signal module.

The beacon switching module may be associated with beacon communications, e.g., a beacon communication channel, a beacon protocol, etc. For the purpose of the present disclosure, beacons are typically signals sent either as part of a message or to augment a message (sometimes referred to herein as “beacon signals”). The beacons may have well-defined characteristics, such as frequency. Beacons may be detected readily in noisy environments and may be used for a trigger to a sniff circuit, such as described below.

In one aspect, the beacon switching module may comprise the beacon wakeup module, having wakeup functionality. Wakeup functionality generally comprises the functionality to operate in high power modes only during specific times, e.g., short periods for specific purposes, to receive a signal, etc. An important consideration on a receiver portion of a system is that it be of low power. This feature may be advantageous in an implanted receiver, to provide for both small size and to preserve a long-functioning electrical supply from a battery. The beacon switching module enables these advantages by having the receiver operate in a high power mode for very limited periods of time. Short duty cycles of this kind can provide optimal system size and energy draw features.

In practice, the receiver may “wake up” periodically, and at low energy consumption, to perform a “sniff function” via, for example, a sniff circuit. For the purpose of the present application, the term “sniff function” generally refers to a short, low-power function to determine if a transmitter is present. If a transmitter signal is detected by the sniff function, the device may transition to a higher power communication decode mode. If a transmitter signal is not present, the receiver may return, e.g., immediately return, to sleep mode. In this manner, energy is conserved during relatively long periods when a transmitter signal is not present, while high-power capabilities remain available for efficient decode mode operations during the relatively few periods when a transmit signal is present. Several modes, and combination thereof, may be available for operating the sniff circuit. By matching the needs of a particular system to the sniff circuit configuration, an optimized system may be achieved.

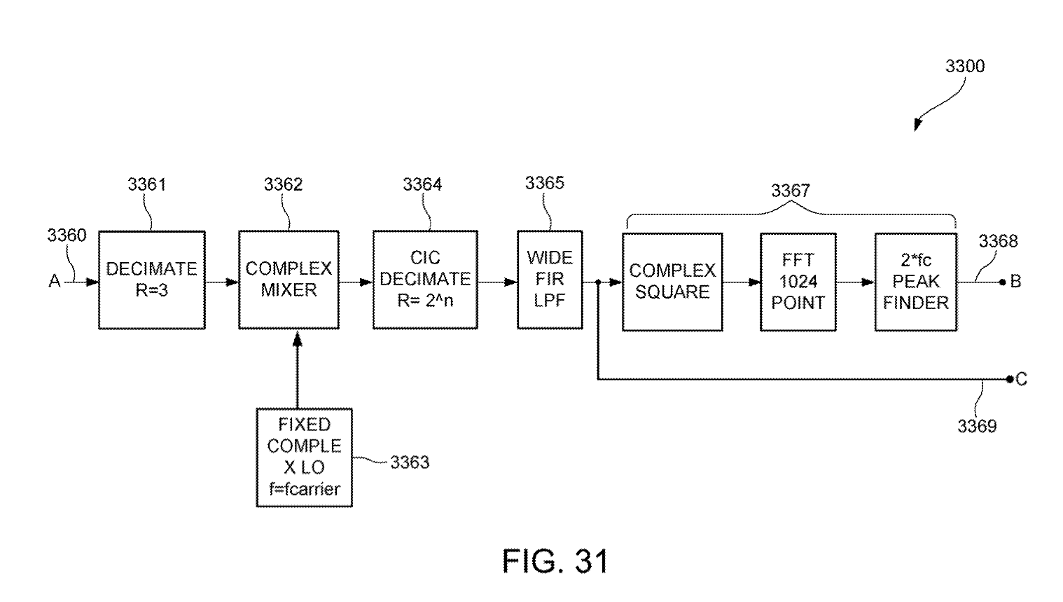

Another view of a beacon module is provided in the functional block diagram shown in FIG. 31. The scheme outlined in FIG. 31 outlines one technique for identifying a valid beacon. The incoming signal 3360 represents the signals received by electrodes, bandpass filtered (such as from 10 KHz to 34 KHz) by a high frequency signaling chain (which encompasses the carrier frequency), and converted from analog to digital. The signal 3360 is then decimated at block 3361 and mixed at the nominal drive frequency (such as, 12.5 KHz, 20 KHz, etc.) at mixer 3362. The resulting signal is decimated at block 3364 and low-pass filtered (such as 5 KHz BW) at block 3365 to produce the carrier signal mixed down to carrier offset-signal 3369. Signal 3369 is further processed by blocks 3367 (fast Fourier transform and then detection of two strongest peaks) to provide the true carrier frequency signal 3368. This protocol allows for accurate determination of the carrier frequency of the transmitted beacon.

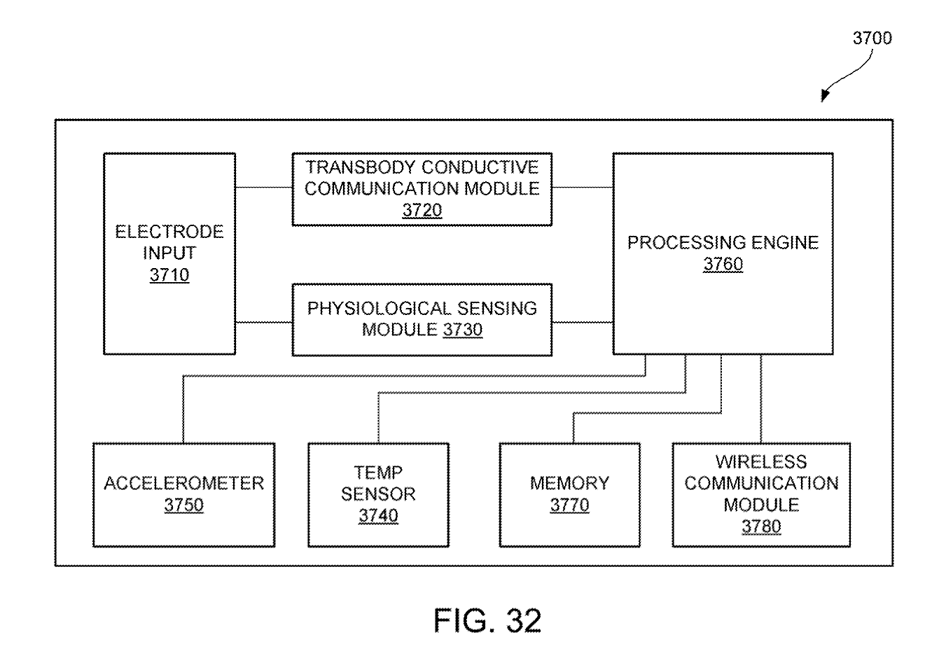

FIG. 32 provides a block functional diagram of an integrated circuit component of a signal receiver according to an aspect of the disclosure. In FIG. 32, a receiver 3700 includes electrode input 3710. Electrically coupled to the electrode input 3710 are transbody conductive communication module 3720 and physiological sensing module 3730. In one aspect, transbody conductive communication module 3720 is implemented as a high frequency (HF) signal chain and physiological sensing module 3730 is implemented as a low frequency (LF) signal chain. Also shown are CMOS temperature sensing module 3740 (for detecting ambient temperature) and a 3-axis accelerometer 3750. Receiver 3700 also includes a processing engine 3760 (for example, a microcontroller and digital signal processor), non-volatile memory 3770 (for data storage) and wireless communication module 3780 (for data transmission to another device, for example in a data upload action).

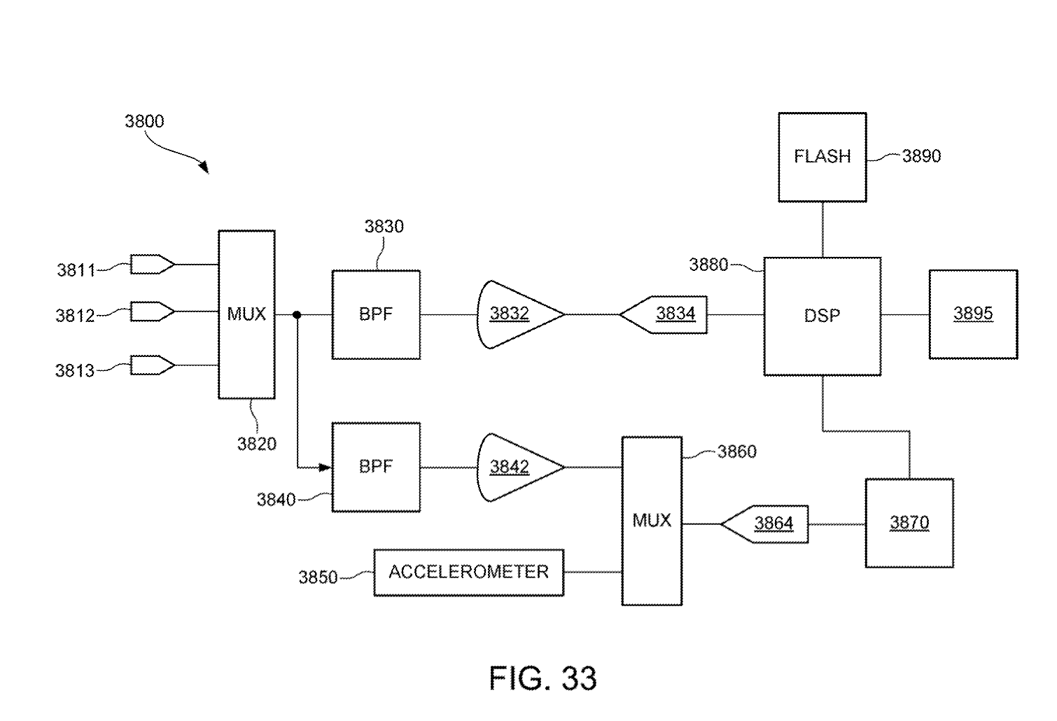

FIG. 33 provides a more detailed block diagram of a circuit configured to implement the block functional diagram of the receiver depicted in FIG. 32, according to one aspect of the disclosure. In FIG. 33, a receiver 3800 includes electrodes e1, e2 and e3 (3811, 3812 and 3813) which, for example, receive the conductively transmitted signals by an IEM and/or sense physiological parameters or biomarkers of interest. The signals received by the electrodes 3811, 3812, and 3813 are multiplexed by multiplexer 3820 which is electrically coupled to the electrodes.

Multiplexer 3820 is electrically coupled to both high band pass filter 3830 and low band pass filter 3840. The high and low frequency signal chains provide for programmable gain to cover the desired level or range. In this specific aspect, high band pass filter 3830 passes frequencies in the 10 KHz to 34 KHz band while filtering out noise from out-of-band frequencies. This high frequency band may vary, and may include, for example, a range of 3 KHz to 300 KHz. The passing frequencies are then amplified by amplifier 3832 before being converted into a digital signal by converter 3834 for input into high power processor 3880 (shown as a DSP) which is electrically coupled to the high frequency signal chain.

Low band pass filter 3840 is shown passing lower frequencies in the range of 0.5 Hz to 150 Hz while filtering out out-of-band frequencies. The frequency band may vary, and may include, for example, frequencies less than 300 Hz, such as less than 200 Hz, including less than 150 Hz. The passing frequency signals are amplified by amplifier 3842. Also shown is accelerometer 3850 electrically coupled to second multiplexer 3860. Multiplexer 3860 multiplexes the signals from the accelerometer with the amplified signals from amplifier 3842. The multiplexed signals are then converted to digital signals by converter 3864 which is also electrically coupled to low power processor 3870.

In one aspect, a digital accelerometer (such as one manufactured by Analog Devices), may be implemented in place of accelerometer 3850. Various advantages may be achieved by using a digital accelerometer. For example, because the signals the digital accelerometer would produce signals already in digital format, the digital accelerometer could bypass converter 3864 and electrically couple to the low power microcontroller 3870—in which case multiplexer 3860 would no longer be required. Also, the digital signal may be configured to turn itself on when detecting motion, further conserving power. In addition, continuous step counting may be implemented. The digital accelerometer may include a FIFO buffer to help control the flow of data sent to the low power processor 3870. For instance, data may be buffered in the FIFO until full, at which time the processor may be triggered to turn awaken from an idle state and receive the data.

Low power processor 3870 may be, for example, an MSP430 microcontroller from Texas Instruments. Low power processor 3870 of receiver 3800 maintains the idle state, which as stated earlier, requires minimal current draw—e.g., 10 μA or less, or 1 μA or less.

High power processor 3880 may be, for example, a VC5509 digital signal process from Texas Instruments. The high power processor 3880 performs the signal processing actions during the active state. These actions, as stated earlier, require larger amounts of current than the idle state—e.g., currents of 30 μA or more, such as 50 μA or more—and may include, for example, actions such as scanning for conductively transmitted signals, processing conductively transmitted signals when received, obtaining and/or processing physiological data, etc.

The receiver may include a hardware accelerator module to process data signals. The hardware accelerator module may be implemented instead of, for example, a DSP. Being a more specialized computation unit, it performs aspects of the signal processing algorithm with fewer transistors (less cost and power) compared to the more general purpose DSP. The blocks of hardware may be used to “accelerate” the performance of important specific function(s). Some architectures for hardware accelerators may be “programmable” via microcode or VLIW assembly. In the course of use, their functions may be accessed by calls to function libraries.

The hardware accelerator (HWA) module comprises an HWA input block to receive an input signal that is to be processed and instructions for processing the input signal; and, an HWA processing block to process the input signal according to the received instructions and to generate a resulting output signal. The resulting output signal may be transmitted as needed by an HWA output block.

Also shown in FIG. 33 is flash memory 3890 electrically coupled to high power processor 3880. In one aspect, flash memory 3890 may be electrically coupled to low power processor 3870, which may provide for better power efficiency.

Wireless communication element 3895 is shown electrically coupled to high power processor 3880 and may include, for example, a BLUETOOTH™ wireless communication transceiver. In one aspect, wireless communication element 3895 is electrically coupled to high power processor 3880. In another aspect, wireless communication element 3895 is electrically coupled to high power processor 3880 and low power processor 3870. Furthermore, wireless communication element 3895 may be implemented to have its own power supply so that it may be turned on and off independently from other components of the receiver—e.g., by a microprocessor.

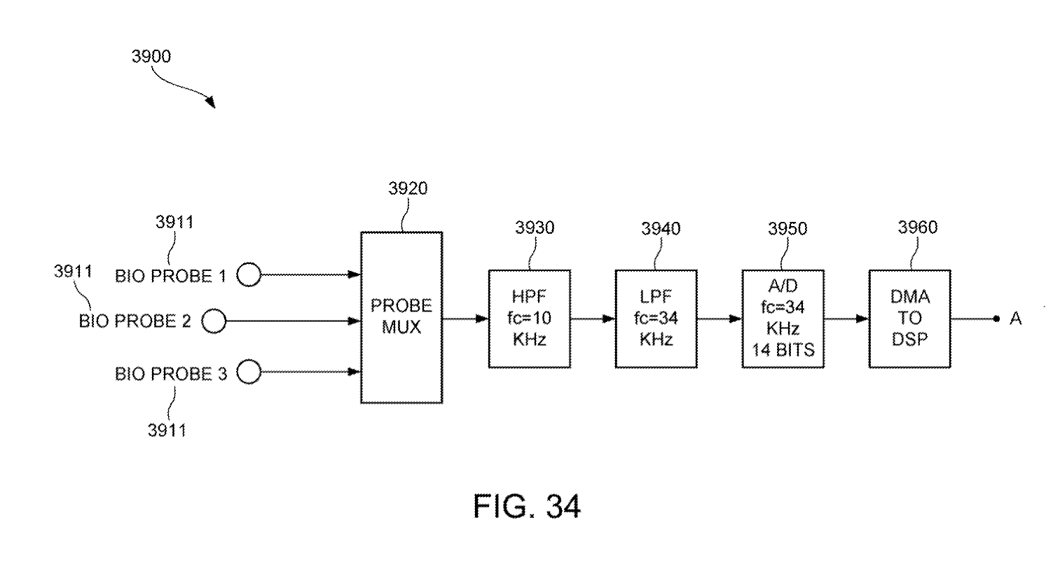

FIG. 34 provides a view of a block diagram of hardware in a receiver according to an aspect of the disclosure related to the high frequency signal chain. In FIG. 34, receiver 3900 includes receiver probes (for example in the form of electrodes 3911, 3912 and 3913) electrically coupled to multiplexer 3920. Also shown are high pass filter 3930 and low pass filter 3940 to provide for a band pass filter which eliminates any out-of-band frequencies. In the aspect shown, a band pass of 10 KHz to 34 KHz is provided to pass carrier signals falling within the frequency band. Example carrier frequencies may include, but are not limited to, 12.5 KHz and 20 KHz. One or more carriers may be present. In addition, the receiver 3900 includes analog to digital converter 3950—for example, sampling at 500 KHz. The digital signal can thereafter be processed by the DSP. Shown in this aspect is DMA to DSP unit 3960 which sends the digital signal to dedicated memory for the DSP. The direct memory access provides the benefit of allowing the rest of the DSP to remain in a low power mode.

As stated earlier, for each receiver state, the high power functional block may be cycled between active and inactive states accordingly. Also, for each receiver state, various receiver elements (such as circuit blocks, power domains within processor, etc.) of a receiver may be configured to independently cycle from on and off by the power supply module. Therefore, the receiver may have different configurations for each state to achieve power efficiency.

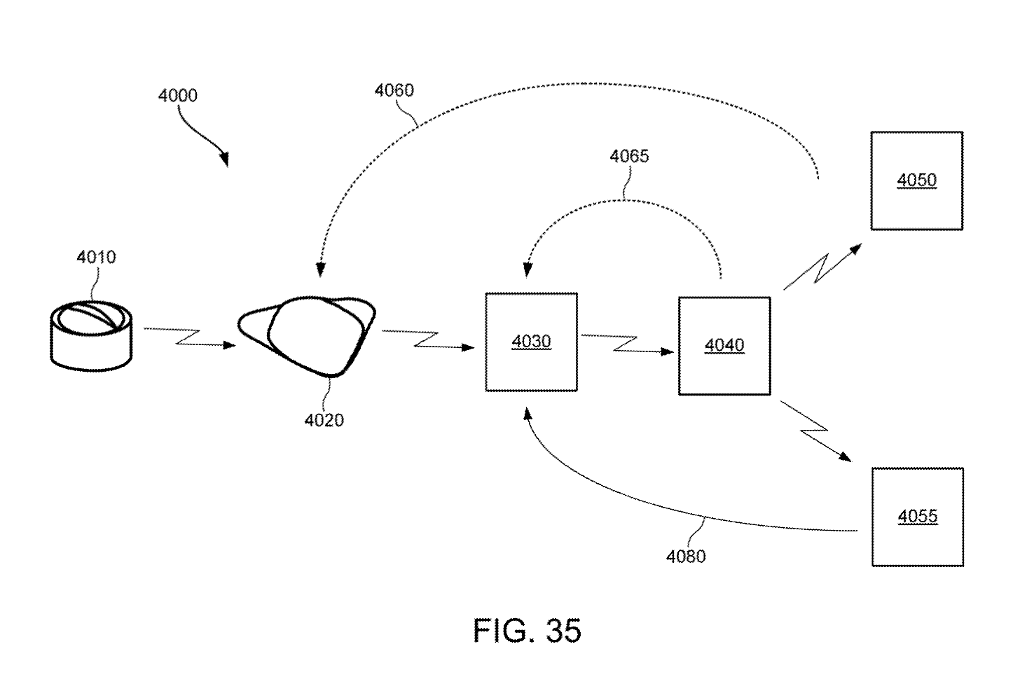

An example of a system of the disclosure is shown in FIG. 35. In FIG. 35, system 4000 includes a pharmaceutical composition 4010 that comprises an IEM. Also present in the system 4000 is signal receiver 4020. Signal receiver 4020 is configured to detect a signal emitted from the identifier of the IEM 4010. Signal receiver 4020 also includes physiologic sensing capability, such as ECG and movement sensing capability. Signal receiver 4020 is configured to transmit data to a patient's an external device or PDA 4030 (such as a smart phone or other wireless communication enabled device), which in turn transmits the data to a server 4040. Server 4040 may be configured as desired, e.g., to provide for patient directed permissions. For example, server 4040 may be configured to allow a family caregiver 4050 to participate in the patient's therapeutic regimen, e.g., via an interface (such as a web interface) that allows the family caregiver 4050 to monitor alerts and trends generated by the server 4040, and provide support back to the patient, as indicated by arrow 4060. The server 4040 may also be configured to provide responses directly to the patient, e.g., in the form of patient alerts, patient incentives, etc., as indicated by arrow 4065 which are relayed to the patient via PDA 4030. Server 4040 may also interact with a health care professional (e.g., RN, physician) 4055, which can use data processing algorithms to obtain measures of patient health and compliance, e.g., wellness index summaries, alerts, cross-patient benchmarks, etc., and provide informed clinical communication and support back to the patient, as indicated by arrow 4080.

It is to be understood that this disclosure is not limited to particular embodiments described, and as such may vary. It is also to be understood that the terminology

1. A method consisting of the steps of: receiving, by a processor, health promotion data; processing, by the processor, the health promotion data to identify at least one preselected behavior change methodology; and generating, by the processor, a corresponding instruction to initiate the identified at least one behavior change methodology,
wherein the health promotion data are generated from at least one event selected from group consisting essentially of an ingestion event, an injection event, an inhalation event, an infusion event, a health monitoring event, a physical activity event, and an eating event,
wherein the ingestion event generating the health promotion data is facilitated via an ingestible device.

2-3. (canceled)

4. The method of claim 1, wherein the ingestible device is selected from a group consisting of an RFID-enabled device and a current-altering device.

5. The method of claim 1, wherein the at least one behavior change methodology is selected from a group consisting essentially of a medmatch methodology; a races within reach methodology; a pick a desktop widget/avatar methodology; a family responsibility methodology; a virtual mansion methodology; a daily hatch methodology; a fitimals methodology; a gamefit methodology; a delightful comparators methodology; an adhere to win methodology; a shame game methodology; a pledge matching methodology; a help from my friends methodology; a love buzz methodology; a patch alerts methodology; a patch communicator methodology; a done! buzz methodology; a plug methodology; a real patient profiles methodology; a real futures methodology; a mood miner methodology; a heart fit methodology; a swimmer patch methodology; a small steps to big results methodology; a commit to healthy eating methodology; a placebo pills methodology; and a matched methodology.

6. The method of claim 5, wherein the medmatch methodology is associated with at least one of direct or indirect support of an individual or cause in need and an economic consequence.

7. The method of claim 5, wherein the medmatch methodology is associated with at least one of a verifiable donation transaction and a quantifiable donation transaction.

8. The method of claim 1, further consisting of an initial step of generating, by a health-promotion device, the health promotion data.

9. The method of claim 8, wherein the health-promotion device is an ingestible device.

10. The method of claim 1, further consisting of a step of receiving, by a device, the corresponding instruction.

11. The method of claim 1, further consisting of at least one step of the steps of: tracking, via a system component, data associated with the health promotion data; and generating feedback, via a system component, associated with the health promotion data.

12. The method of claim 1, further consisting of a step of generating, via a system component, a preventative action instruction associated with the health promotion data.

13. A system, comprising: health promotion data generated by a device; a methodology module associated with a processor to identify at least one behavior change methodology associated with the health promotion data; an instruction module associated with the processor to initiate the identified at least one behavior change methodology; and a data device to at least one of generate the health promotion data and communicate the health promotion data.

14. (canceled)

15. The system of claim 13, wherein the data device is selected from a group consisting essentially of an ingestible device, an injection device, an inhalation device, an infusion device, a detector device, a health monitoring device, a physical activity device, an implantable device, a drug depot release device, and an eating device.

16. The system of claim 15, wherein the ingestible device encodes the health promotion data in a current flow.

17. The system of claim 16, wherein the ingestible device comprises: a control device for altering conductance; and a partial power source comprising: a first material electrically coupled to the control device; and a second material electrically coupled to the control device and electrically isolated from the first material; wherein the first and second materials are selected to provide a voltage potential difference when in contact with a conducting liquid, and wherein the control device alters the conductance between the first and second materials such that the magnitude of the current flow is varied to encode the health promotion data.

18. The system of claim 15, wherein the detector device communicates at least one of medication delivery event data and physiologic parameter data.

19. The system of claim 13, further comprising a tracking/feedback module to at least one of track data associated with the health promotion data and generate feedback associated with the health promotion data.

20. The system of claim 13, further comprising a preventative action module to generate a preventative action instruction associated with the health promotion data.

21. An article comprising: a non-transitory storage medium having instructions, that when executed by a computing platform, result in execution of a method of communicating health promotion data via a network, comprising: receiving, via a hub, the health promotion data; communicating, via the hub, at least a portion of the health promotion data to a methodology module;
identifying, via a methodology module, at least one methodology associated with the health promotion data; and
generating, via an instruction module, at least one instruction associated with the identified methodology, and
further comprising at least one of the following steps of: tracking, via a component of the network, data associated with the health promotion data; and generating, via a component of the network, data associated with the health promotion data.

22. (canceled)

23. The article of claim 21, further comprising a step of generating, via a component of the network, a preventative action instruction associated with the health promotion data.

24. (canceled)
